(19) United States
(12) Patent Application Publication
(10) Pub. No.: US 2024/0054639 A1
(43) Pub. Date: Feb. 15, 2024

(54) QUANTIFICATION OF CONDITIONS ON BIOMEDICAL IMAGES ACROSS STAINING MODALITIES USING A MULTI-TASK DEEP LEARNING FRAMEWORK

(71) Applicants: Memorial Sloan-Kettering Cancer Center, New York, NY (US); Sloan-Kettering Institute for Cancer Research, New York, NY (US); Memorial Hospital for Cancer and Allied Diseases, New York, NY (US)

(72) Inventors: Saad NADEEM, New York, NY (US); Travis HOLLMANN, New York, NY (US)

(21) Appl. No.: 18/260,459

(22) PCT Filed: Jan. 7, 2022
(86) PCT No.: PCT/US22/11559

§ 371 Date: Jul. 5, 2023

Related U.S. Application Data
(60) Provisional application No. 63/134,696, filed on Jan. 7, 2021.
(60) Provisional application No. 63/181,734, filed on Apr. 29, 2021.

(51) Int. Cl. G06T 7/00; G06T 7/11

(52) U.S. Cl. CPC G06T 7/0012; G06T 7/11; G06T 2207/10056; G06T 2207/10064; G06T 2207/20081; G06T 2207/20084; G06T 2207/30024

(57) ABSTRACT

Presented herein are systems and methods of quantifying conditions on biomedical images. A computing system may identify a first biomedical image in a first staining modality. The first biomedical image having at least one region of interest (ROI) corresponding to a condition. The computing system may apply a trained image segmentation model to the first biomedical image. The trained image segmentation model may generate a second biomedical image in a second staining modality using the first biomedical image in the first staining modality. The trained image segmentation model may generate a segmented biomedical image using the first biomedical image and the second biomedical image. The computing system may determine a score for the condition based on one or more ROIs identified in the segmented biomedical image. The computing system may provide an output based on the second biomedical, image, the score for condition, or the segmented biomedical image.

### CROSS REFERENCE TO RELATED APPLICATIONS

The present application claims benefit of priority to U.S. Provisional Patent Application No. 63/134,696, titled “Quantification Using Deep Learning Multiplex Immunofluorescence Re-Staining,” filed Jan. 7, 2021 and U.S. Provisional Patent Application No. 63/181,734, titled “Quantification of Immunohistochemistry Images Using a Multi-Task Deep Learning Framework,” filed Apr. 29, 2021, each of which are incorporated herein by reference in their entireties.

### BACKGROUND

A computing device may use various computer vision algorithms to detect and recognize various objects depicted in digital images. The models for such algorithms may be trained in accordance with various learning techniques.

### SUMMARY

Aspects of the present disclosure are directed to systems, methods, computer-readable media for training models to quantify conditions on biomedical images. A computing system may identify a training dataset comprising a plurality of biomedical images in a corresponding plurality of staining modalities. The plurality of biomedical images may have at least a first biomedical image in a first staining modality of the plurality of staining modalities. The first biomedical image may have at least one region of interest (ROI) associated with a condition. The computing system may establish an image segmentation network using the training dataset. The image segmentation network may have a first model having a first plurality of kernels and a second model having a second plurality of kernels. The first model may generate a second biomedical image in a second staining modality using the first biomedical image in the first staining modality. The first model may generate a segmented biomedical image using the first biomedical image and the second biomedical image. The segmented biomedical image may identify the ROI. The second model may generate a classification using the segmented biomedical image. The classification may indicate whether the segmented biomedical image is generated using the first model. The computing system may determine an error metric based on the classification generated by the second model. The computing system may update at least one of the first plurality of kernels in the first model or the second plurality of kernels in the second model using the error metric. The computing system may store the first plurality of kernels in the first model of the image segmentation network for generating scores for presence of the condition in biomedical images.

In some embodiments, the computing system may apply, subsequent to convergence of the image segmentation network, the first model of the image segmentation network to an acquired biomedical image in one of the plurality of staining modalities to generate a second segmented biomedical image. The second segmented biomedical image may identify one or more ROIs associated with the condition in the acquired biomedical images. In some embodiments, the computing system may determine a score for the condition in the acquired biomedical image based on a number of the one or more ROIs.

In some embodiments, the training dataset may include a labeled biomedical image associated with the plurality of biomedical images. The labeled biomedical image may identify the at least one ROI in at least the first biomedical image. In some embodiments, the second model may generate the classification using at least one of the segmented biomedical image or the labeled biomedical image, the classification indicating whether the segmented biomedical image or the labeled biomedical image is input into the second model.

In some embodiments, the second model may generate a second classification using at least one of the second biomedical image or a biomedical image of the plurality of biomedical images in the second staining modality. The second classification may indicate whether the second biomedical image or the biomedical image is input into the second model. In some embodiments, the computing system may determine the loss metric based on the second classification generated by the second model.

In some embodiments, the first plurality of kernels of the first model may arranged across a plurality of first blocks, a plurality of second blocks, and a third block. The plurality of first blocks may correspond to the plurality of staining modalities besides the first staining modality. The first plurality of blocks may generate a corresponding plurality of second biomedical images corresponding to the first biomedical image. Each of the plurality of second biomedical images may be in a staining modality different from the first staining modality. The plurality of second blocks may correspond to the plurality of staining modalities. The plurality of second blocks may generate a corresponding plurality of segmented biomedical images using the plurality of second biomedical images. The third block may generate the segmented biomedical image using the plurality of segmented biomedical images.

In some embodiments, the second plurality of kernels of the second model may be arranged across a plurality of first blocks and a plurality of second blocks. The plurality of first blocks may correspond to the plurality of staining modalities besides the first staining modality. The plurality of first blocks may generate a plurality of first classifications using a plurality of second biomedical images generated using the first biomedical image. The plurality of second blocks may correspond to the plurality of staining modalities. The plurality of second blocks may generate a plurality of second classifications using a plurality of segmented biomedical images.

In some embodiments, each of the plurality of biomedical images in the training dataset may be derived from a tissue sample in accordance with immunostaining of a corresponding staining modality of the plurality of staining modalities. In some embodiments, the plurality of staining modalities for the plurality of biomedical images may correspond to a respective plurality of antigens present in the tissue sample.

Aspects of the present disclosure are directed to systems, methods, and computer-readable media for quantifying conditions on biomedical images. A computing system may identify a first biomedical image in a first staining modality. The first biomedical image having at least one region of interest (ROI) corresponding to a condition. The computing system may apply a trained image segmentation model to the first biomedical image. The trained image segmentation model may include a plurality of kernels. The trained image segmentation model may generate a second biomedical image in a second staining modality using the first biomedical image in the first staining modality. The trained image segmentation model may generate a segmented biomedical image using the first biomedical image and the second biomedical image, the segmented biomedical image identifying one or more ROIs. The computing system may determine a score for the condition in the first biomedical image based on the one or more ROIs identified in the segmented biomedical image. The computing system may provide an output based on at least one of the second biomedical image, the score for the condition, or the segmented biomedical image.

In some embodiments, the computing system may establish the trained image segmentation model using a training dataset. The training dataset may have (i) a plurality of unlabeled biomedical images in the corresponding plurality of staining modalities and (ii) a labeled biomedical image identifying at least one ROI in one of the plurality of unlabeled biomedical images.

In some embodiments, the first plurality of kernels of the first model may arranged across a plurality of first blocks, a plurality of second blocks, and a third block. The plurality of first blocks may correspond to the plurality of staining modalities besides the first staining modality. The first plurality of blocks may generate a corresponding plurality of second biomedical images corresponding to the first biomedical image. Each of the plurality of second biomedical images may be in a staining modality different from the first staining modality. The plurality of second blocks may correspond to the plurality of staining modalities. The plurality of second blocks may generate a corresponding plurality of segmented biomedical images using the plurality of second biomedical images. The third block may generate the segmented biomedical image using the plurality of segmented biomedical images.

In some embodiments, the computing system may determine a plurality of scores for the plurality of staining modalities based on a plurality of segmented images corresponding to the plurality of staining modalities. In some embodiments, the computing system may receive the first biomedical image acquired from a tissue sample in accordance with immunostaining of the first staining modality. The first biomedical image may have the at least one ROI corresponding to a feature associated with the condition in the tissue sample. In some embodiments, the computing system may generate information to present based on the score for the condition and the segmented biomedical image. The segmented biomedical image may identify the one or more ROIs. The one or more ROIs may correspond to one of a presence of the condition or an absence of the condition.

Aspects of the present disclosure are directed to systems, methods, and computer-readable media for converting staining modalities in biomedical images. A computing system may identify a first biomedical image in a first staining modality. The first biomedical image may have at least one region of interest (ROI) corresponding to a condition. The computing system may convert the first biomedical image from the first staining modality to a second staining modality to generate a second biomedical image. The computing system may generate a segmented biomedical image by applying an image segmentation network to at least one of the first biomedical image or the second biomedical image. The segmented biomedical image may identify one or more ROIs. The computing system may provide an output identifying information based on at least one of the second biomedical image or the segmented biomedical image.

### BRIEF DESCRIPTION OF THE DRAWINGS

The objects, aspects, features, and advantages of the disclosure will become more apparent and better understood by referring to the following description taken in conjunction with the accompanying drawing, in which:

FIG. 1. Overview of DeepLIIF pipeline and sample input IHCs (different brown/DAB markers—BCL2, BCL6, CD10, CD3/CD8, Ki67) with corresponding DeepLIIF-generated hematoxylin/mpIF modalities and classified (positive (red) and negative (blue) cell) segmentation masks. (a) Overview of DeepLIIF. Given an IHC input, the multitask deep learning framework simultaneously infers corresponding Hematoxylin channel, mpIF DAPI, mpIF protein expression (Ki67, CD3, CD8, etc.), and the positive/negative protein cell segmentation, baking explainability and interpretability into the model itself rather than relying on coarse activation/attention maps. In the segmentation mask, the red cells denote cells with positive protein expression (brown/DAB cells in the input IHC), whereas blue cells represent negative cells (blue cells in the input IHC). (b) Example DeepLIIF-generated hematoxylin/mpIF modalities and segmentation masks for different IHC markers. DeepLIIF, trained on clean IHC Ki67 nuclear marker images, can generalize to noisier as well as other IHC nuclear/cytoplasmic marker images.

FIGS. 2(a)-(d). Qualitative and quantitative analysis of DeepLIIF against other semantic segmentation models tested on BC Dataset. (a) Three example images from the training set. (b) A segmentation mask showing Ki67− and Ki67+ cell representation, along with a visual segmentation and classification accuracy. Predicted classes are shown in different colors where blue represents Ki67− and red represents Ki67+ cells, and the hue is set using the loge of the ratio between the predicted area and ground-truth area. Cells with too large areas are shown in dark colors, and cells with too small areas are shown in a light color. For example, if the model correctly classifies a cell as Ki67+, but the predicted cell area is too large, the cell is colored in dark red. If there is no cell in the ground-truth mask corresponding to a predicted cell, the predicted cell is shown in yellow, which means that the cell is misclassified (cell segmented correctly but classified wrongly) or missegmented (no cell in the segmented cell area). (c) The accuracy of the segmentation and classification is measured by getting the average of Dice score, Pixel Accuracy, absolute value of IHC Quantification difference between the predicted segmentation mask of each class and the ground-truth mask of the corresponding class (0 indicates no agreement and 100 indicates perfect agreement). Evaluation of all scores shows that DeepLIIF outperforms all models. (d) As mentioned earlier, DeepLIIF generalizes across different tissue types and imaging platforms. Two example images from the BC Dataset (9) along with the inferred modalities and generated classified segmentation masks are shown in the top rows where the ground-truth mask and segmentation masks of five models are shown in the second row. The mean IOU and Pixel Accuracy are given for each model in the box below the image.

FIGS. 3(a)-(d). Qualitative and quantitative analysis of DeepLIIF against other semantic segmentation models tested on NuClick Dataset and four sample images from the LYON19 challenge dataset . (a) A segmentation mask showing CD3/CD8+ cells, along with a visual segmentation and classification accuracy. Predicted CD3/CD8+ cells are shown in red color, and the hue is set using the log₂ of the ratio between the predicted area and ground-truth area. Cells with too large areas are shown in dark colors, and cells with too small areas are shown in a light color. For example, if the model correctly classifies a cell as CD3/CD8+, but the predicted cell area is too large, the cell is colored in dark red. If there is no cell in the ground-truth mask corresponding to a predicted cell, the predicted cell is shown in yellow, which means that the cell is missegmented (no corresponding ground-truth cell in the segmented cell area). (b) The accuracy of the segmentation and classification is measured by getting the average of Dice score, Pixel Accuracy, and IOU (intersection over union) between the predicted segmentation mask of CD3/CD8 and the ground-truth mask of the corresponding cells (0 indicates no agreement and 100 indicates perfect agreement). Evaluation of all scores shows that DeepLIIF outperforms all models. (c) As mentioned earlier, DeepLIIF generalizes across different tissue types and imaging platforms. Two example images from the NuClick Dataset (21) along with the modalities and classified segmentation masks generated by DeepLIIF, are shown in the top rows where the ground-truth mask and quantitative segmentation masks of DeepLIIF and models are shown in the second row. The mean IOU and Pixel Accuracy are given for each generated mask. (d) Randomly chosen samples from the LYON19 challenge dataset . The top row shows the IHC image, and the bottom row shows the classified segmentation mask generated by DeepLIIF. In the mask, the blue color shows the boundary of negative cells, and the red color shows the boundary of positive cells.

FIG. 4. The t-SNE plot of tested IHC markers on DeepLIIF. The structure of the testing dataset is visualized by applying t-SNE to the image styles tested on DeepLIIF. The IHC protein markers in the tested datasets were embedded using t-SNE. Each point represents an IHC image of its corresponding marker. Randomly chosen example images of each marker are shown around the t-SNE plot. The black circle shows the cluster of training images. The distribution of data points shows that DeepLIIF is able to adapt to images with various resolutions, color and intensity distributions, and magnifications captured in different clinical settings, and successfully segment and classify the heterogeneous collection of testing sets covering eight different IHC markers.

FIG. 5. IHC quantification of four cancer type images taken from Protein Atlas IHC Ki67 dataset. In each row, a sample is shown along with the inferred modalities and the classified segmentation mask. The demographic information of the patient and the details about the staining, along with the manual protein score and the predicted score by DeepLIIF are reported next to each sample.

FIG. 6. Overview of DeepLIIF. The network consists of a generator and a discriminator component. It uses ResNet-9block generator for generating the modalities including Hematoxylin, mpIF DAPI, mpIF Lap2, and mpIF Ki67 and UNet512 generator for generating the segmentation mask. In the segmentation component, the generated masks from IHC, Hematoxylin, mpIF DAPI, and mpIF Lap2 representations are averaged with pre-defined weights to create the final segmentation mask. The discriminator component consists of the modalities discriminator module and segmentation discriminator module.

FIGS. 7(a)-(c). Qualitative and quantitative analysis of DeepLIIF against detection models on the testing set of the BC Data. (a) An example IHC image from the BC Data testing set, the generated modalities, segmentation mask overlaid on the IHC image, and the detection mask generated by DeepLIIF. (b) The detection masks generated by the detection models. In the detection mask, the center of a detected positive cell is shown with red dot and the center of a detected negative cell is shown with blue dot. It is shown that the missing positive cells in cyan bounding boxes, the missing negative cells in yellow bounding boxes, the wrongly detected positive cells in blue bounding boxes, the wrongly detected negative cells in pink bounding boxes. (c) The detection accuracy is measured by getting average of precision

$$( \frac{TP}{TP + FP} ) ,$$

recall

$$( \frac{TP}{TP + FN} ) ,$$

and f1-score

$$( \frac{2 \times precision \times recall}{precision + recall} )$$

between the predicted detection mask of each class and the ground-truth mask of the corresponding class. A predicted point is regarded as true positive if it is within the region of a ground-truth point with a predefined radius (set to 10 pixels in the experiment which is similar to the predefined radius in). Centers that have been detected more than once are considered as false positive. Evaluation of all scores show that DeepLIIF outperforms all models.

FIGS. 8(a)-(c). Quantitative and qualitative analysis of DeepLIIF on modality inference. (a) The Quantitative analysis of the synthetic data against the real data using MSE, SSIM, Inception Score, and FID. The low value of MSE (close to 0) and the high value of SSIM (close to 1) shows that the model generates high quality synthetic images similar to real images. (b) Visualization of first two components of PCA applied to synthetic and real images. First, a feature vector was calculated for each image using VGG16 model and then PCA was applied on the calculated feature vectors and visualized the first two components. As shown in the figure, the synthetic image data points have the same distribution as the real image data points, showing that the generated images by the model have the same characteristics as the real images. (c) The original/real and model-inferred modalities of two samples taken from Bladder and Lung tissues are shown side-by-side.

FIG. 9. LAP2beta coverage for normal tissues. LAP2beta immunohistochemistry reveals nuclear envelope-specific staining in the majority of cells in spleen (99.98%), colon (99.41%), pancreas (99.50%), placenta (76.47%), testis (95.59%), skin (96.74%), lung (98.57%), liver (98.70%), kidney (95.92%) and lymph node (99.86%).

FIGS. 10(a) and 10(b). Qualitative and quantitative analysis of DeepLIIF against the same model without using mpIF Lap2, referred to as noLap2 model. (a) A qualitative comparison of DeepLIIF against noLap2 model. (b) Some example IHC images. The first image in each row shows the input IHC image. In the second image, the generated mpIF Lap2 image is overlaid on the classified/segmented IHC image. The third and fourth images show the segmentation mask, respectively, generated by DeepLIIF and noLap2.

FIG. 11. Application of DeepLIIF on some H&E sample images taken from MonuSeg Dataset. DeepLIIF, trained solely on IHC images stained with Ki67 marker, was tested on H&E images. In each row, the inferred modalities and the segmentation mask overlaid on the original H&E sample are shown.

FIGS. 12(a) and (b). Overview of synthetic IHC image generation. (a) A training sample of the IHC-generator model. (b) Some samples of synthesized IHC images using the trained IHC-Generator model. The Neg-to-Pos shows the percentage of the negative cells in the segmentation mask converted to positive cells.

FIG. 13. Samples taken from the PathoNet IHC Ki67 breast cancer dataset along with the inferred modalities and classified segmentation mask marked by manual centroid annotations created from consensus of multiple pathologists. The IHC images were acquired in low-resource settings with microscope camera. In each row, the sample IHC image along with the inferred modalities are shown. The overlaid classified segmentation mask generated by DeepLIIF with manual annotations are shown in the furthest right column. The blue and red boundaries represent the negative and positive cells predicted by the model, while the pink and yellow dots show the manual annotations of the negative and positive cells, respectively.

FIGS. 14(a) and 14(b). Microscopic snapshots of IHC images stained with two different markers along with inferred modalities and generated classified segmentation mask.

FIG. 15. Some examples from LYON19 Challenge Dataset. The generated modalities and classified segmentation mask for each sample are in a separate row.

FIG. 16. Examples of tissues stained with various markers. The top box shows sample tissues stained with BCL2, BCL6, CD10, MYC, and MUM1 from DLBCL-morph dataset. The bottom box shows sample images stained with TP53 marker from the Human Protein Atlas. In each row, the first image on the left shows the original tissue stained with a specific marker. The quantification score computed by the classified segmentation mask generated by DeepLIIF is shown on the top of the whole tissue image, and the predicted score by pathologists is shown on the bottom. In the following images of each row, the modalities and the classified segmentation mask of a chosen crop from the original tissue are shown.

FIG. 17 is a block diagram depicting a system for quantifying conditions in biomedical images in accordance with an illustrative embodiment.

FIG. 18(a) is a sequence diagram depicting a process of training an image segmentation network in the system for quantifying conditions in biomedical images in accordance with an illustrative embodiment.

FIG. 18(b) is a block diagram depicting an architecture for the image segmentation network in the system for quantifying conditions in biomedical images in accordance with an illustrative embodiment.

FIG. 18(c) is a block diagram depicting an architecture for a generator in the image segmentation network in the system for quantifying conditions in biomedical images in accordance with an illustrative embodiment.

FIG. 18(d) is a block diagram depicting an architecture for a generator block in the generator of the image segmentation network in the system for quantifying conditions in biomedical images in accordance with an illustrative embodiment.

FIG. 18(e) is a block diagram depicting a deconvolution stack in the generator in the image segmentation network in the system for quantifying conditions in biomedical images in accordance with an illustrative embodiment.

FIG. 18(f) is a block diagram depicting an architecture for a discriminator in the image segmentation network in the system for quantifying conditions in biomedical images in accordance with an illustrative embodiment.

FIG. 18(g) is a block diagram depicting an architecture for a classifier block in the discriminator of the image segmentation network in the system for quantifying conditions in biomedical images in accordance with an illustrative embodiment.

FIG. 18(h) is a block diagram depicting a convolution stack in the generator in the image segmentation network in the system for quantifying conditions in biomedical images in accordance with an illustrative embodiment.

FIG. 19 is a block diagram depicting a process of applying an image segmentation network in the system for quantifying conditions in biomedical images in accordance with an illustrative embodiment.

FIG. 20(a) is a flow diagram depicting a method of training models to quantify conditions on biomedical images in accordance with an illustrative embodiment.

FIG. 20(b) is a flow diagram depicting a method of quantifying conditions on biomedical images in accordance with an illustrative embodiment.

FIG. 20(c) is a flow diagram depicting a method of converting stain modalities in biomedical images in accordance with an illustrative embodiment.

FIG. 21 is a block diagram of a server system and a client computer system in accordance with an illustrative embodiment.

The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

### DETAILED DESCRIPTION

Following below are more detailed descriptions of various concepts related to, and embodiments of, systems and methods for maintaining databases of biomedical images. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes deep learning-inferred multiplex immunofluorescence for immunohistochemistry (IHC) quantification;

Section B describes systems and methods of quantifying conditions on biomedical images and converting staining modalities in biomedical images;

Section C describes a network environment and computing environment which may be useful for practicing various embodiments described herein.

### A. Deep Learning-Inferred Multiplex Immunofluorescence for Immunohistochemistry (IHC) Quantification

Reporting biomarkers assessed by routine immunohistochemical (IHC) staining of tissue is broadly used in diagnostic pathology laboratories for patient care. To date, clinical reporting is predominantly qualitative or semi-quantitative. By creating a multitask deep learning framework referred to as DeepLIIF, presented herein is a single-step solution to stain deconvolution/separation, cell segmentation, and quantitative single-cell IHC scoring. Leveraging a unique de novo dataset of co-registered IHC and multiplex immunofluorescence (mpIF) staining of the same slides, low-cost and prevalent IHC slides are segmented and translated to more expensive-yet-informative mpIF images, while simultaneously providing the essential ground truth for the superimposed brightfield IHC channels. Moreover, a new nuclear-envelop stain, LAP2beta, with high (>95%) cell coverage is introduced to improve cell delineation/segmentation and protein expression quantification on IHC slides. By simultaneously translating input IHC images to clean/separated mpIF channels and performing cell segmentation/classification, it is shown that the model trained on clean IHC Ki67 data can generalize to more noisy and artifact-ridden images as well as other nuclear and non-nuclear markers such as CD3, CD8, BCL2, BCL6, MYC, MUM1, CD10, and TP53. The method is evaluated on benchmark datasets as well as against pathologists' semi-quantitative scoring.

### Introduction

The assessment of protein expression using immunohistochemical staining of tissue sections on glass slides is critical for guiding clinical decision-making in several diagnostic clinical scenarios, including cancer classification, residual disease detection, and even mutation detection (BRAFV600E and NRASQ61R). Brightfield chromogenic IHC staining, while high throughput, has a narrow dynamic range and results in superimposed channels with high chromogen/stain overlap, requiring specialized digital stain deconvolution or separation, as an preprocessing step in both research as well as commercial IHC quantification algorithms. Stain deconvolution is an open problem requiring extensive hyper-parameter tuning (on per-case basis) or (highly-error prone and time consuming) manual labeling of different cell types, but still results in sub-optimal color separation in regions of high chromogen overlap.

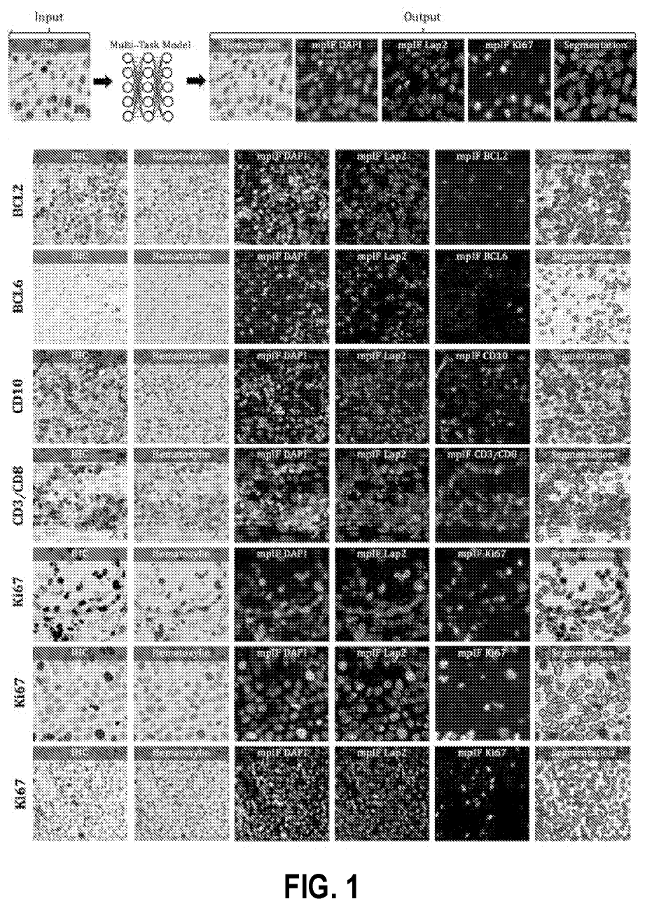

As opposed to brightfield IHC staining, multiplex immunofluorescence (mpIF) staining provides the opportunity to examine panels of several markers individually (without requiring stain deconvolution) or simultaneously as a composite permitting accurate co-localization, stain standardization, more objective scoring, and cut-offs for all the markers' values (especially in low-expression regions, which are difficult to assess on IHC stained slides and can be misconstrued as negative due to weak staining that can be masked by the hematoxylin counterstain). Moreover, mpIF was shown to have a higher diagnostic prediction accuracy (at par with multimodal cross-platform composite approaches) than IHC scoring, tumor mutational burden, or gene expression profiling. However, mpIF assays are expensive and not widely available. This can lead to a unique opportunity to leverage the advantages of mpIF to improve the explainability and interpretability of the IHCs using deep learning breakthroughs. Current deep learning methods for scoring IHCs rely solely on the error-prone manual annotations (unclear cell boundaries, overlapping cells, and challenging assessment of low-expression regions) rather than on co-registered high-dimensional imaging of the same tissue samples (that can provide essential ground truth for the superimposed brightfield IHC channels). Therefore, presented herein is a new multitask deep learning algorithm that leverages a unique co-registered IHC and mpIF training data of the same slides to simultaneously translate low-cost/prevalent IHC images to high-cost and more informative mpIF representations (creating a Deep-Learning-Inferred IF image), accurately auto-segment relevant cells, and quantify protein expression for more accurate and reproducible IHC quantification; using multitask learning to train models to perform a variety of tasks rather than one narrowly defined task makes them more generally useful and robust. Specifically, once trained, DeepLIIF takes only IHC image as input (e.g., Ki67 protein IHC as a brown Ki67 stain with hematoxylin nuclear counterstain) and completely bypassing stain deconvolution, produces/generates corresponding hematoxylin, mpIF nuclear (DAPI), mpIF protein (e.g., Ki67), mpIF LAP2Beta (a new nuclear envelop stain with >95% cell coverage to better separate touching/overlapping cells) channels and segmented/classified cells (e.g., Ki67+and Ki67-cell masks for estimating Ki67 proliferation index which is an important clinical prognostic metric across several cancer types), as shown in FIG. 1. Moreover, DeepLIIF trained just on clean IHC Ki67 images generalizes to more noisy and artifact-ridden images as well as other nuclear and non-nuclear markers such as CD3, CD8, BCL2, BCL6, MYC, MUM1, CD10, and TP53. Example IHC images stained with different markers along with the DeepLIIF inferred modalities and segmented/classified nuclear masks are also shown in FIG. 1. DeepLIIF presents a single-step solution to stain deconvoluion, cell segmentation, and quantitative single-cell IHC scoring. Additionally, the co-registered mpIF data, for the first time, creates an orthogonal dataset to confirm and further specify the target brightfield IHC staining characteristics.

### Results

In this section, the performance of DeepLIIF is evaluated on cell segmentation and classification tasks. The performance of the model and other methods are evaluated using pixel accuracy (PixAcc) computed from the number of true positives, TP, false positives, FP and false negatives, FN, as

$$\frac{TP}{TP + FP + FN} ,$$

Dice Score as

$$\frac{2 \times TP}{2 \times TP + FP + FN} ,$$

and IOU as the class-wise intersection over the union. These metrics may be computed for each class, including negative and positive, and compute the average value of both classes for each metric. A pixel is counted as TP if it is segmented and classified correctly. A pixel is considered FP if it is falsely segmented as the foreground of the corresponding class. A pixel is counted as FN if it is falsely detected as the background of the corresponding class. For example, assuming the model segments a pixel as a pixel of a negative cell (blue), but in the ground-truth mask, it is marked as positive (red). Since there is no corresponding pixel in the foreground of the ground-truth mask of the negative class, it is considered FP for the negative class and FN for the positive class, as there is no marked corresponding pixel in the foreground of the predicted mask of the positive class. The model is evaluated against other methods using Aggregated Jaccard Index (AJI) which is an object-level metric, defined as

$$\frac{{\sum }_{i = 1}^{N} \vert {G}_{i} ⋂ {P}_{M}^{i} \vert}{{\sum }_{i = 1}^{N} \vert {G}_{i} ⋃ {P}_{m}^{i} \vert + {\sum }_{F ∈ U} \vert {P}_{F} \vert} .$$

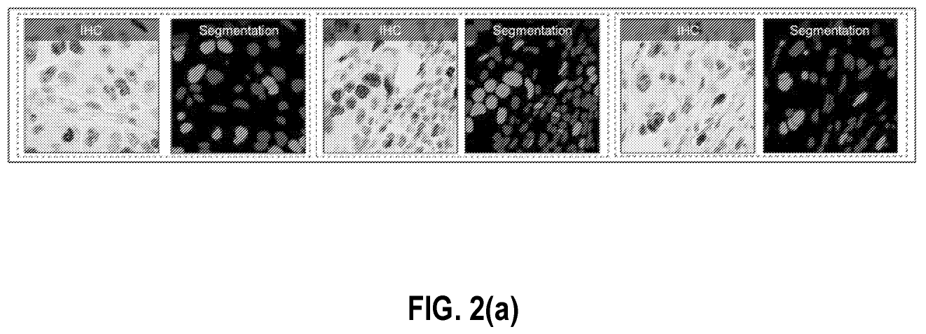

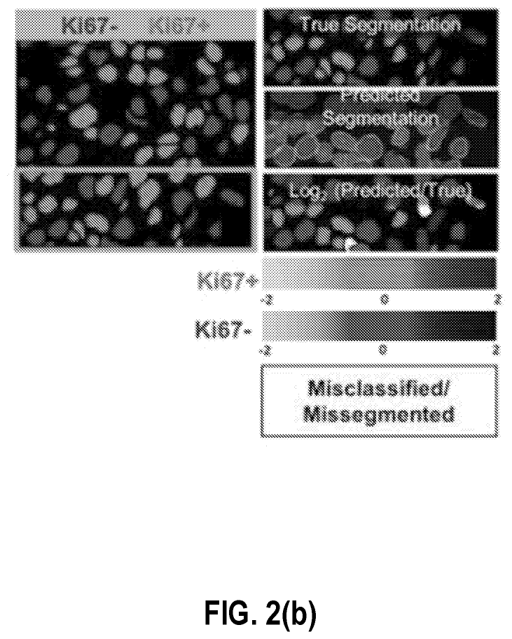

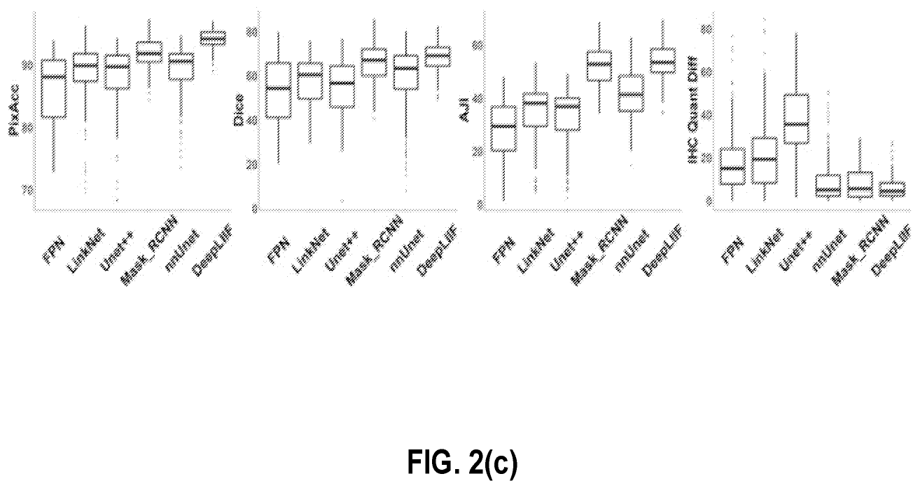

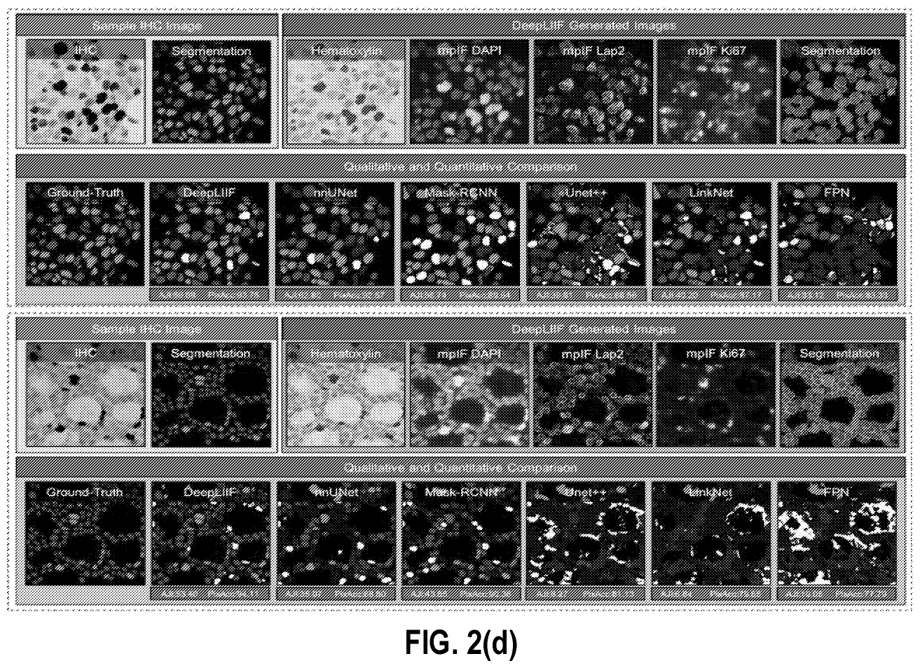

Considering that the goal is an accurate interpretation of IHC staining results, the difference between the IHC quantification percentage of the predicted mask and the real mask is computed, as shown in FIGS. 2(a)-(d).

To compare the model with other models, three different datasets are used. 1) All models are evaluated on the internal test set, including 600 images of size 512×512 and 40× magnification from bladder carcinoma and non-small cell lung carcinoma slides. 2) 41 images of size 640 640 from the BCDataset which contains Ki67 stained sections of breast carcinoma from scanned whole slide images with manual Ki67+ and Ki67− cell centroid annotations (targeting cell detection as opposed to cell instance segmentation task), created from consensus of 10 pathologists, are randomly selected and segemnted. These tiles were split into 164 images of size 512 512; the test set varies widely in the density of tumor cells and the Ki67 index. 3) The model and others were tested on a CD3 and CD8 IHC NuClick Dataset. The training set of BC Dataset containing 671 IHC patches of size 256 256, extracted from LYON19 dataset was used. LYON19 provides a dataset and an evolution platform to benchmark existing algorithms for lymphocyte detection in IHC stained specimens. The dataset contains IHC images of breast, colon, and prostate stained with an antibody against CD3 or CD8.

Trained on clean lung and bladder images stained with Ki67 marker, DeepLIIF generalizes well to other markers. Segmentation networks, including FPN, LinkNet, Mask_RCNN, Unet++, and nnU-Net were also trained on the training set (described in Section Training Data) using the IHC images as the input and generating the colored segmentation mask representing normal cells and lymphocytes. DeepLIIF outperformed previous models trained and tested on the same data on all three metrics. All models were trained and tested on a desktop with an NVIDIA Quadro RTX 6000 GPU, which was also used for all implementations.

The DeepLIIF model's performance was compared against models on the test set obtained from BC-Dataset. The results were analyzed both qualitatively and quantitatively, as shown in FIGS. 2(a)-(d). All models are trained and validated on the same training set as the DeepLIIF model.

Application of DeepLIIF to the BC Dataset resulted in a pixel accuracy of 94.18%, Dice score of 68.15%, IOU of 53.20%, AJI of 53.48%, and IHC quantification difference of 6.07%, and outperformed Mask_RCNN with pixel accuracy of 91.95%, IOU of 66.16%, Dice Score of 51.16%, AJI of 52.36% , and IHC quantification difference of 8.42%, nnUnet with pixel accuracy of 89.24%, Dice Score of 58.69%, IOU of 43.44%, AJI of 41.31%, and IHC quantification difference of 9.84%, UNet++ with pixel accuracy of 87.99%, Dice Score of 54.91%, IOU of 39.47%, AJI of 32.53%, and IHC quantification difference of 36.67%, LinkNet with pixel accuracy of 88.59%, Dice score of 33.64%, IOU of 41.63%, AJI of 33.64%, and IHC quantification difference of 21.57%, and FPN with pixel accuracy of 85.78%, Dice score of 52.92%, OU of 38.04%, AJI of 27.71%, and IHC quantification difference of 17.94%, while maintaining lower standard deviation on all metrics. A significance test was also performed to show that DeepLIIF significantly outperforms other models. As mentioned earlier, all models are trained and tested on the exact same dataset, meaning that the data is paired. Therefore, a paired Wilcoxon rank-sum test was performed, where a p-value of 5% or lower is considered statistically significant. All tests are two-sided, and the assumption of normally distributed data was tested using a Shapiro-Wilk test. The computed p-values of all metrics show that DeepLIIF significantly outperforms the models.

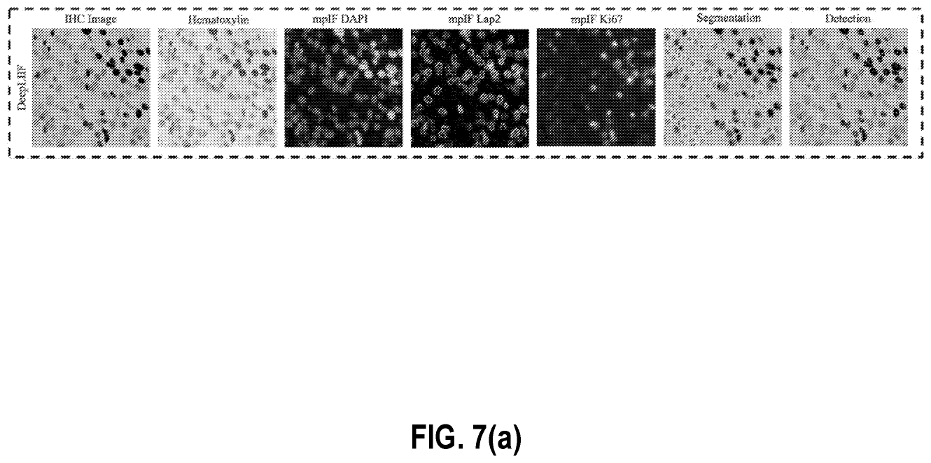

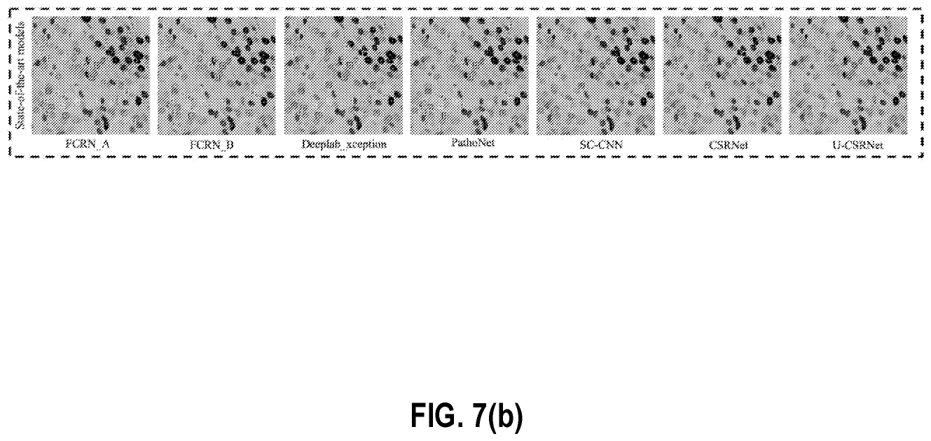

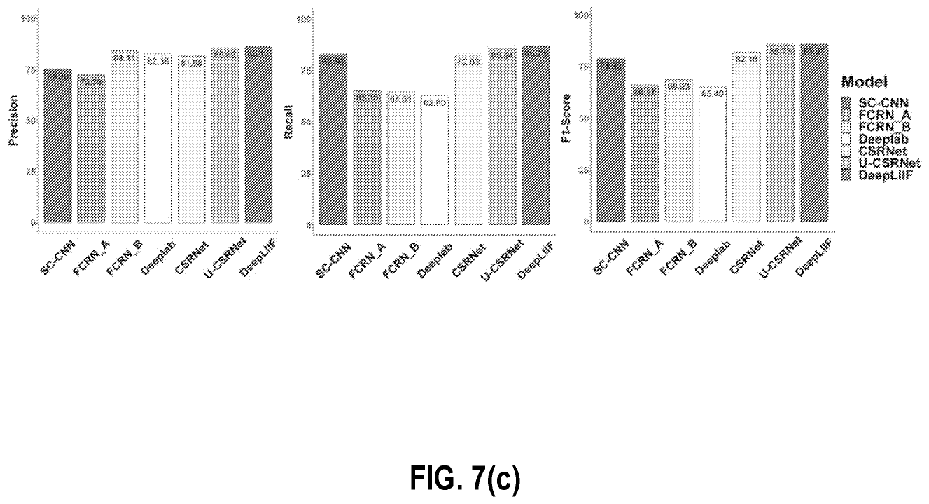

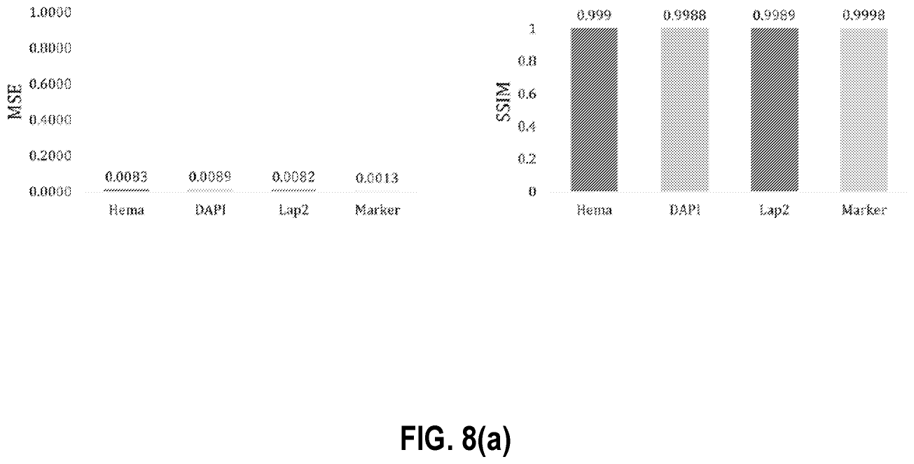

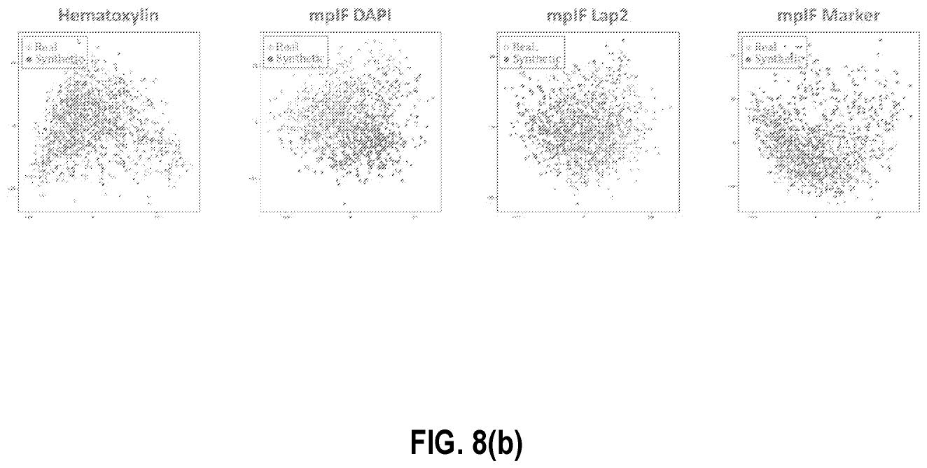

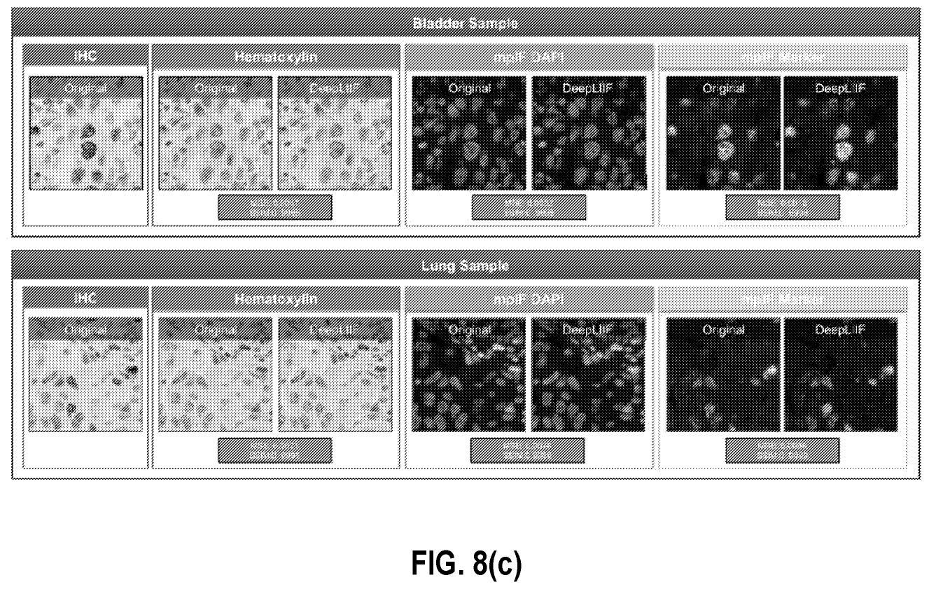

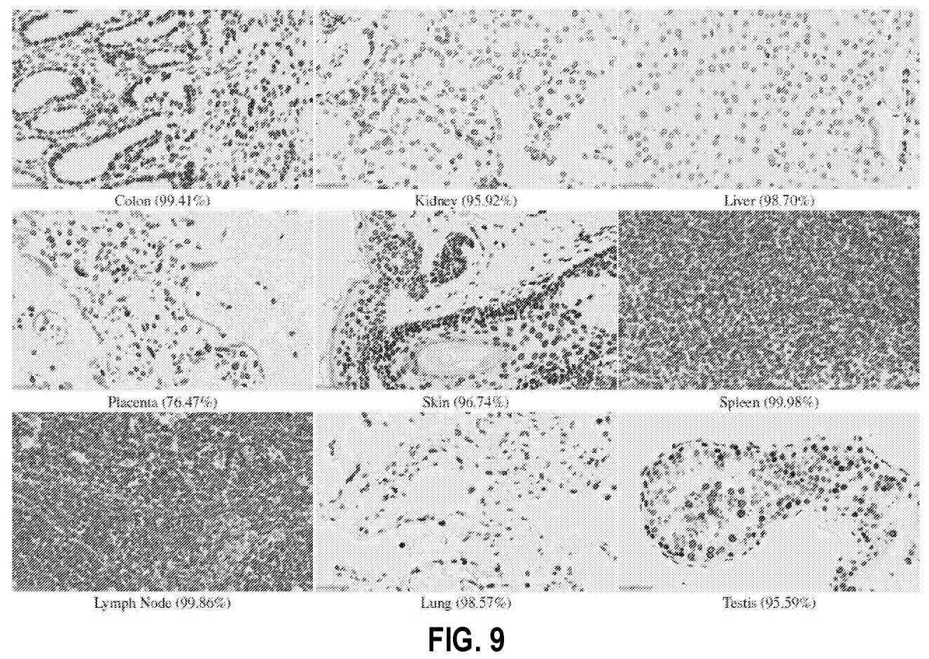

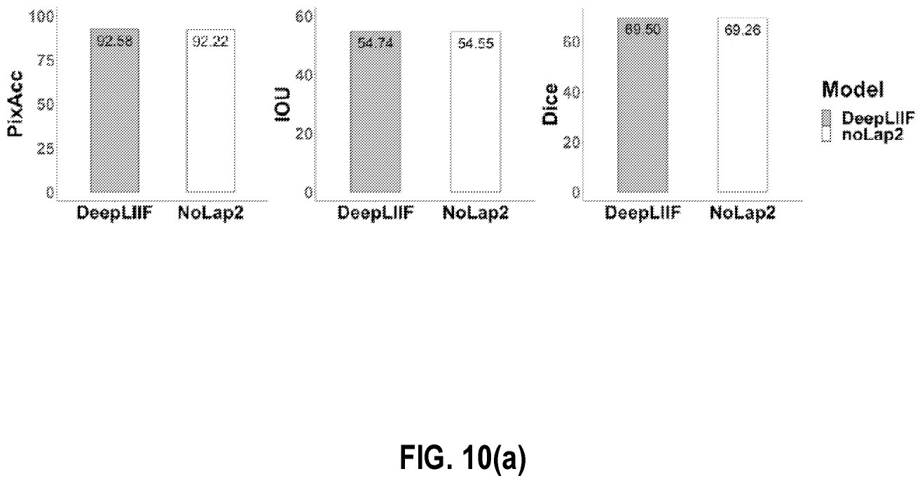

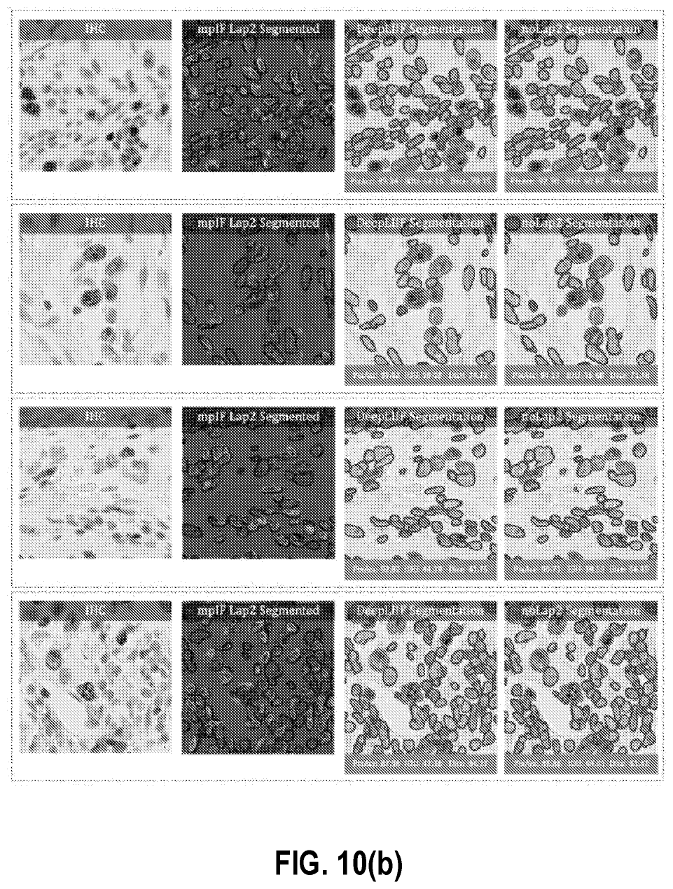

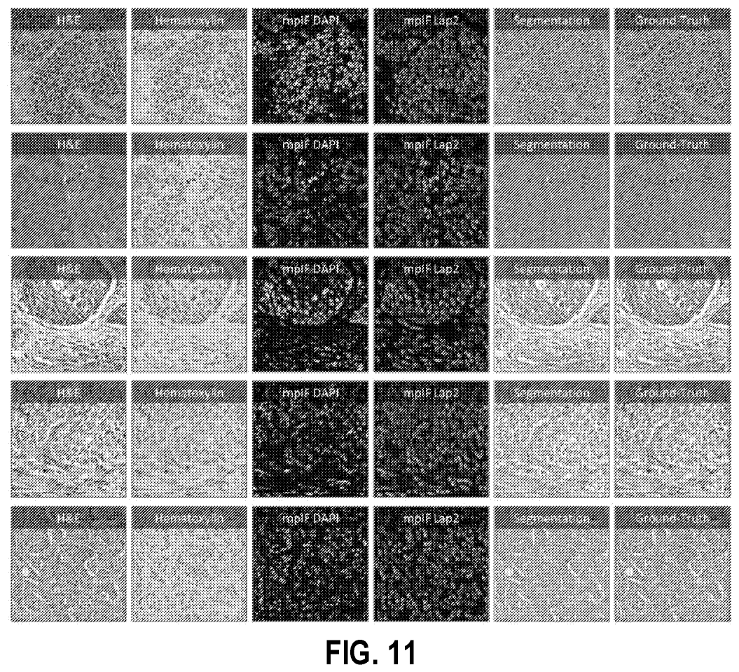

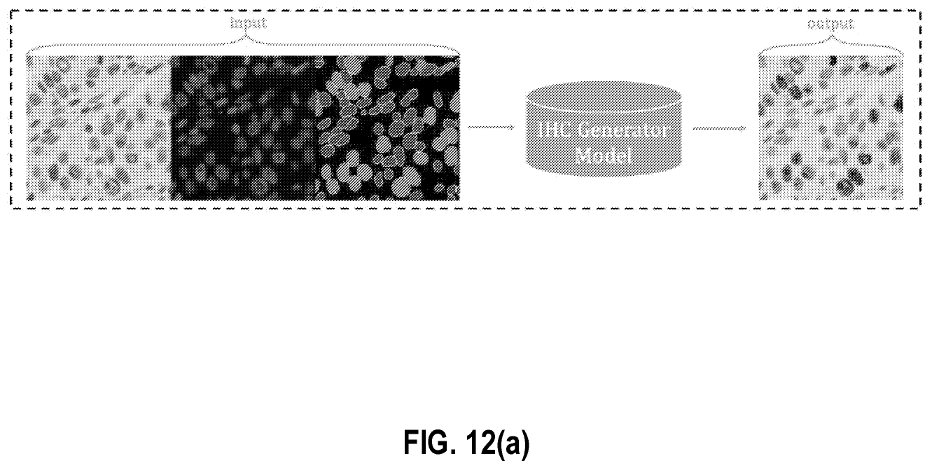

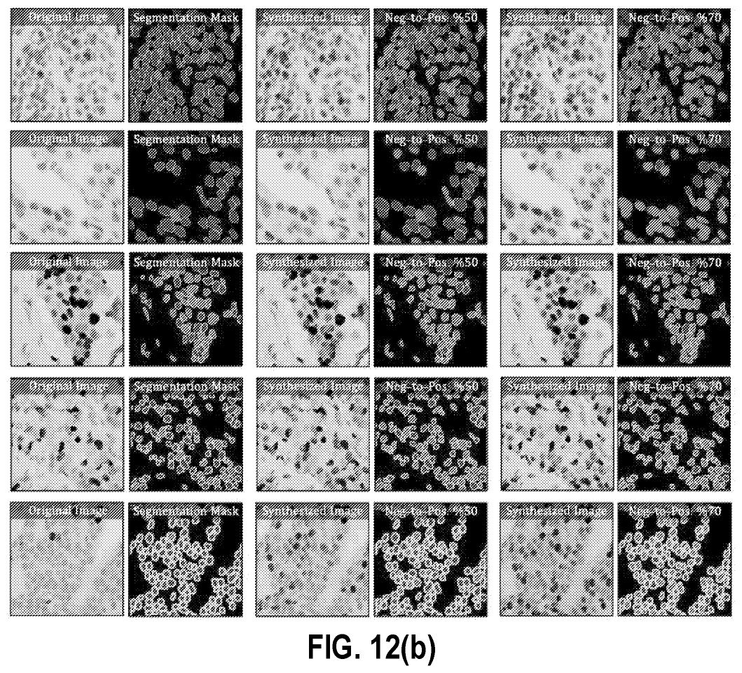

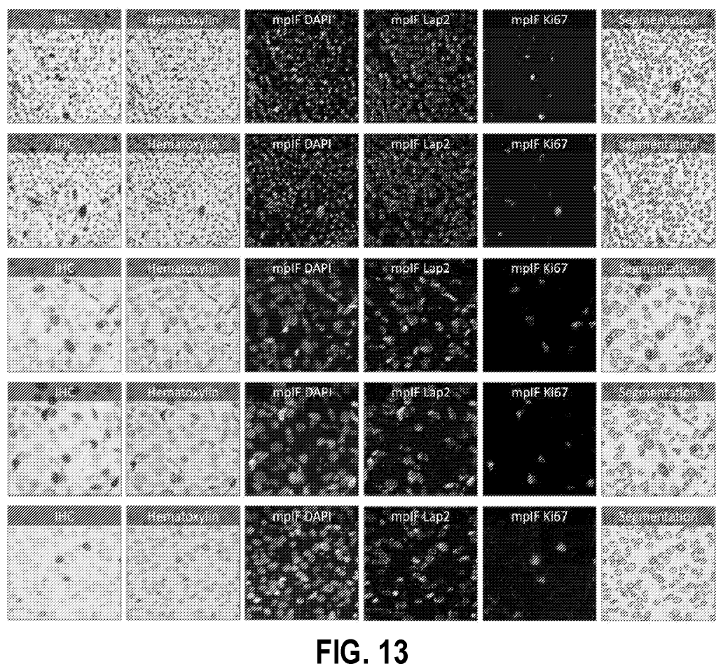

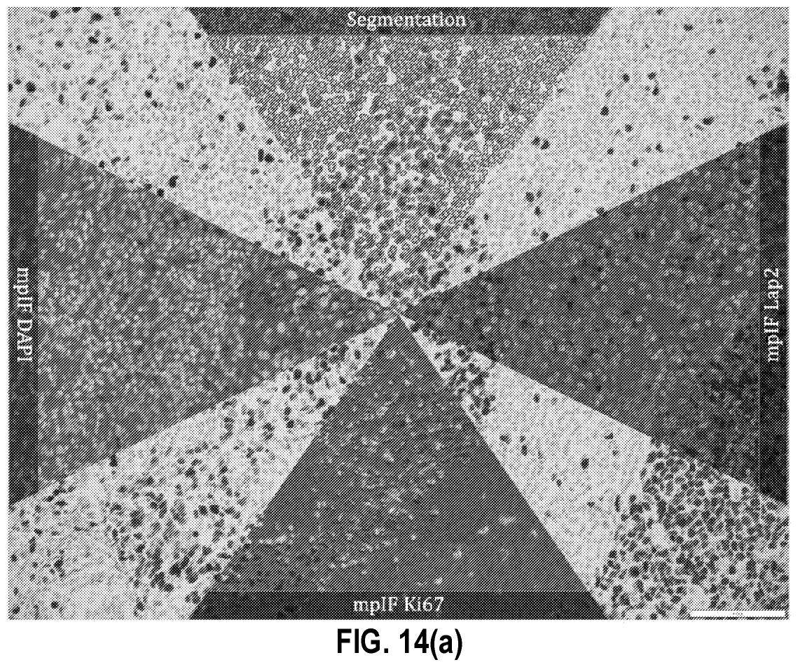

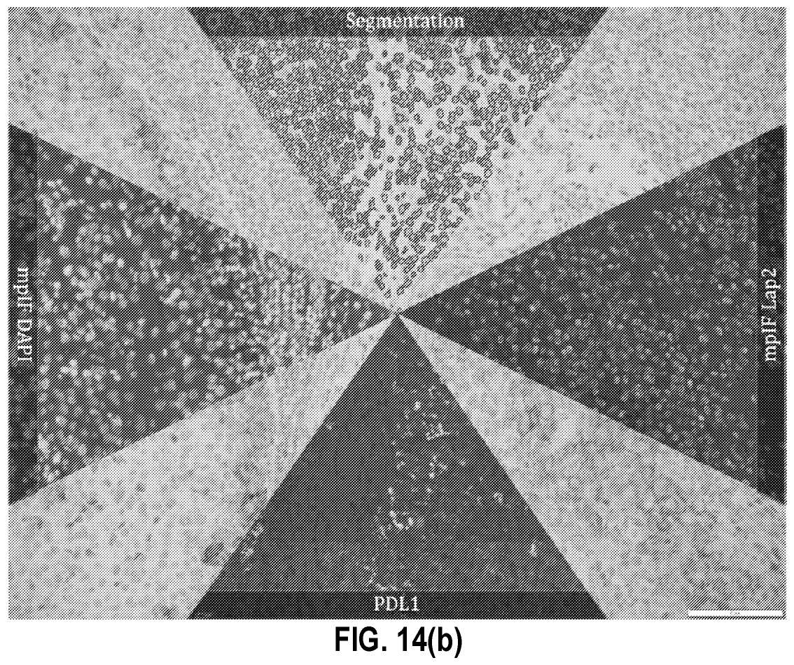

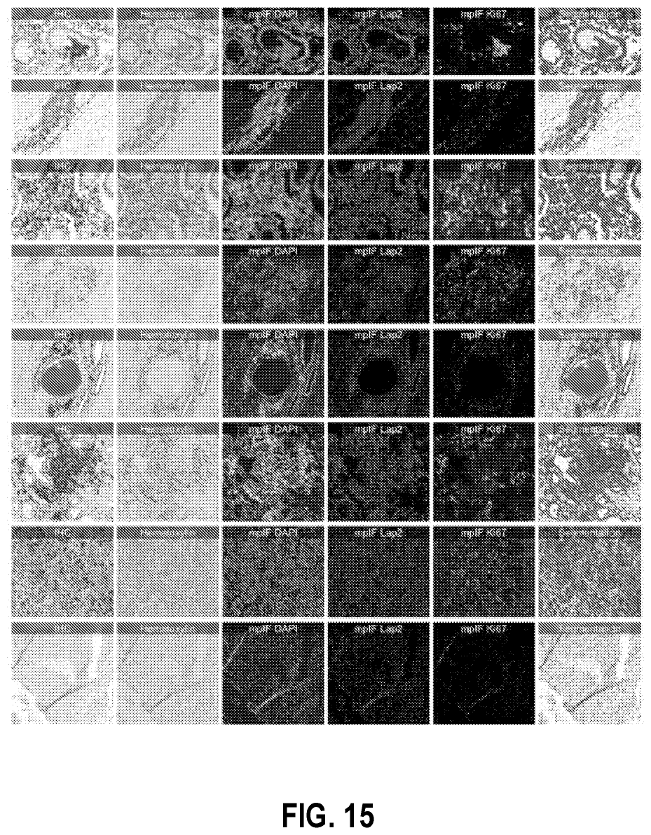

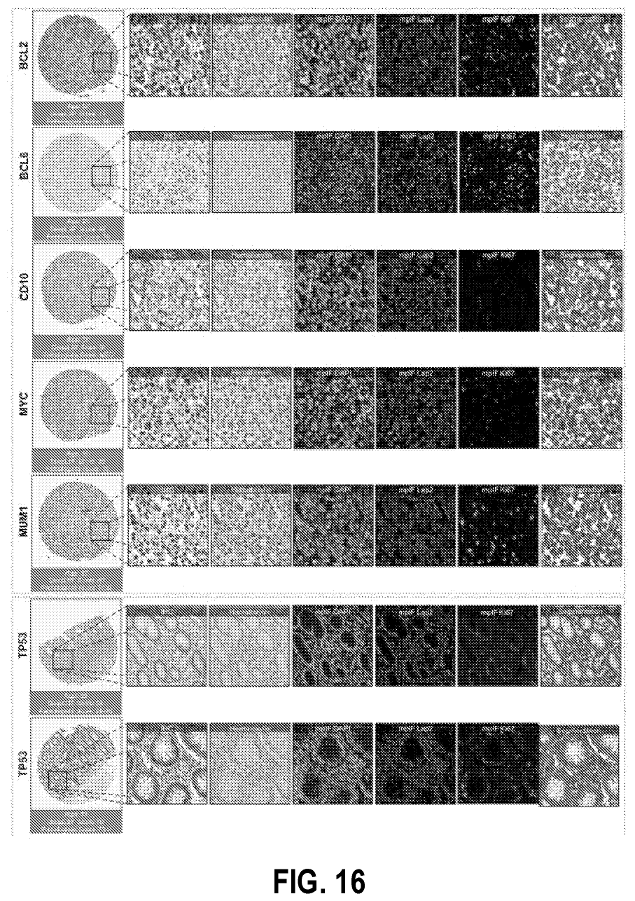

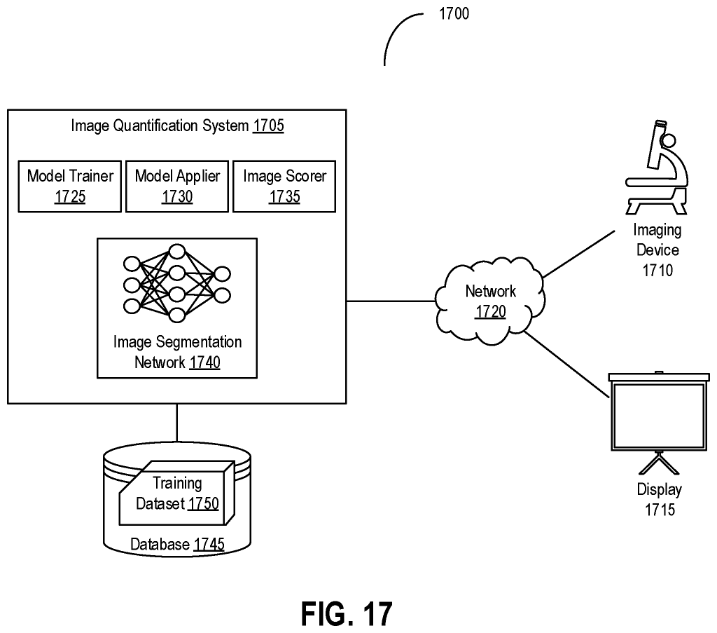

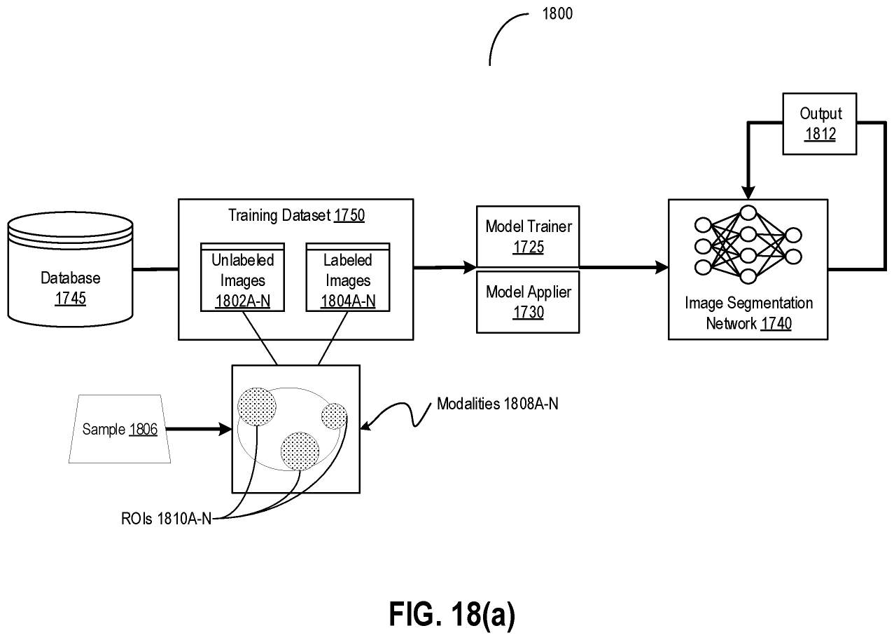

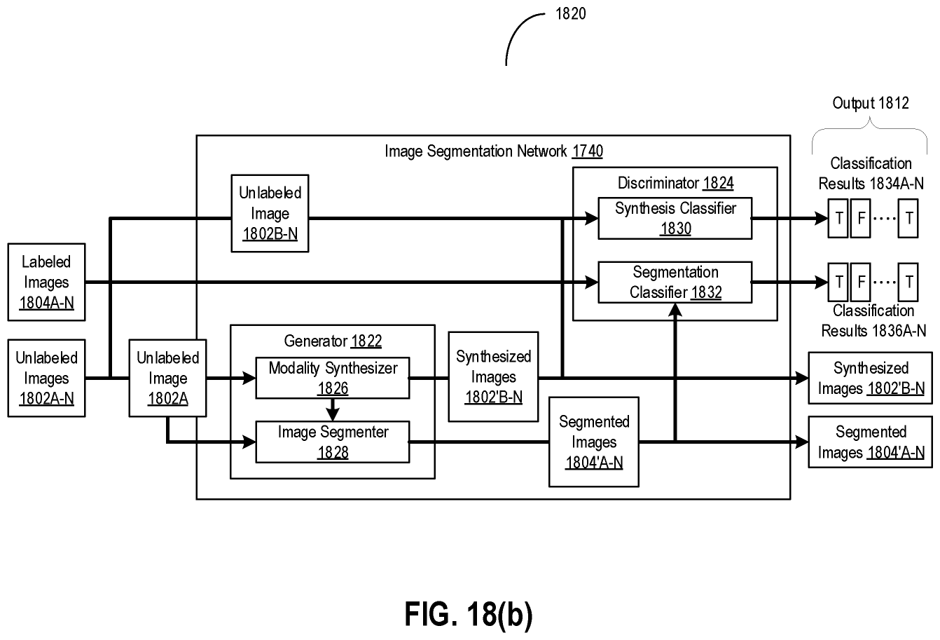

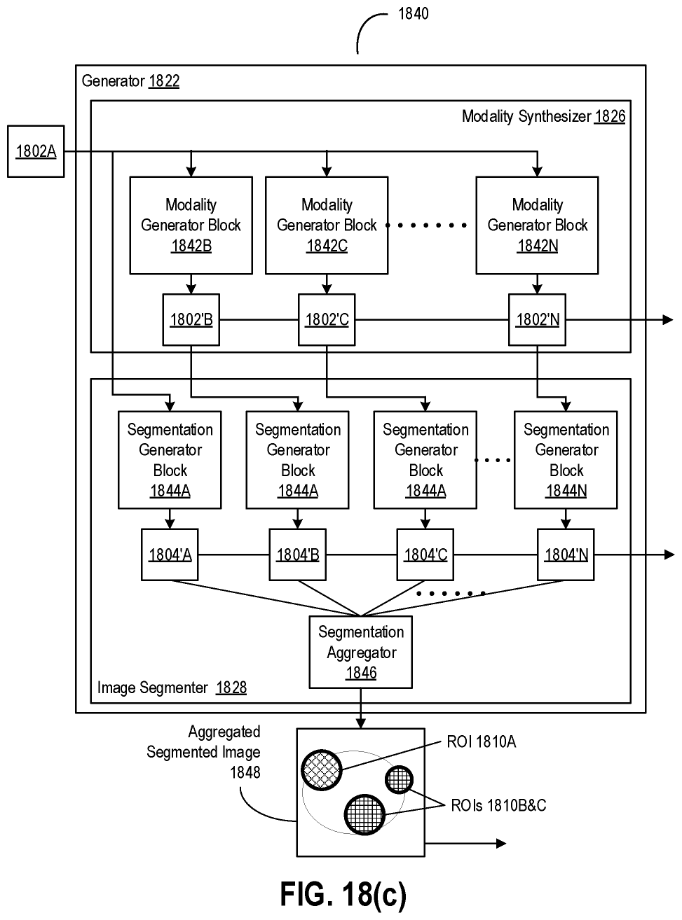

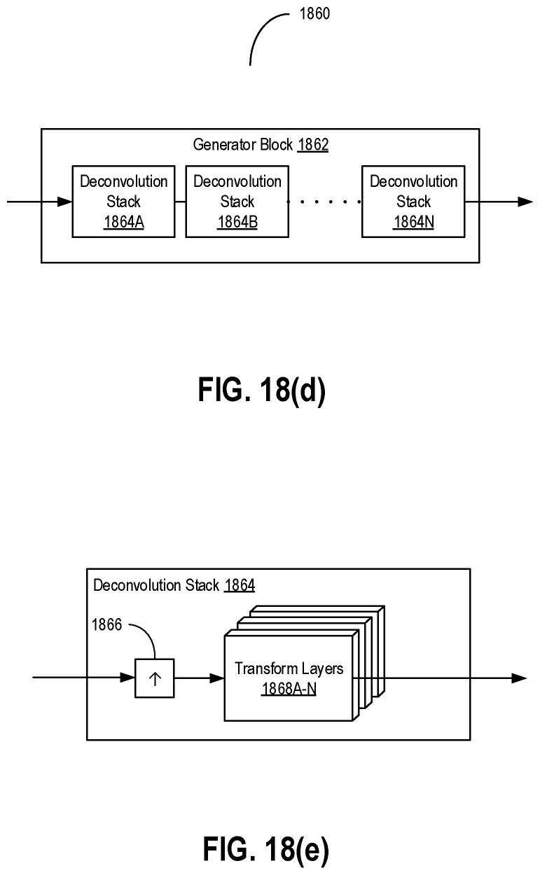

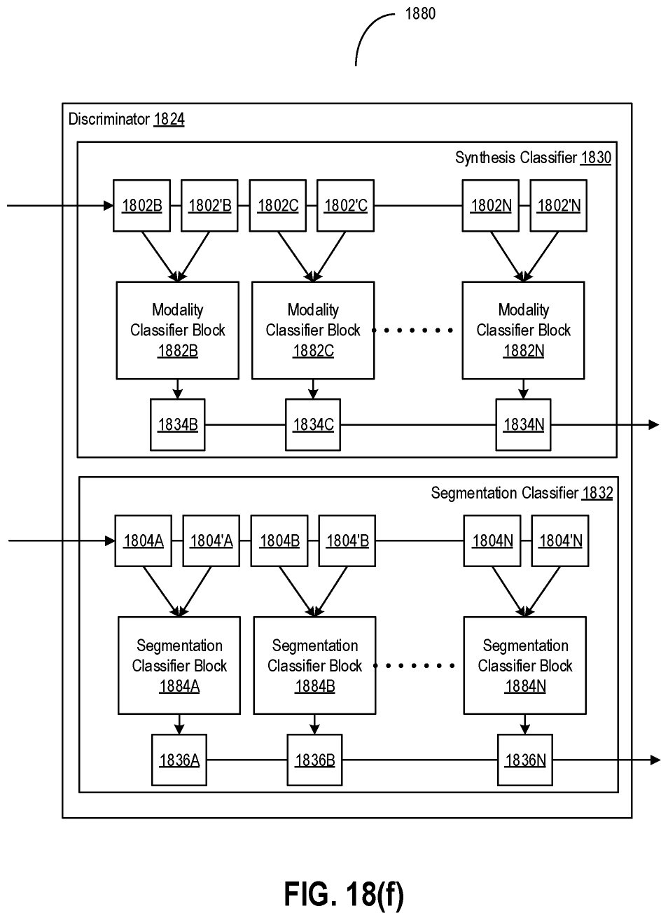

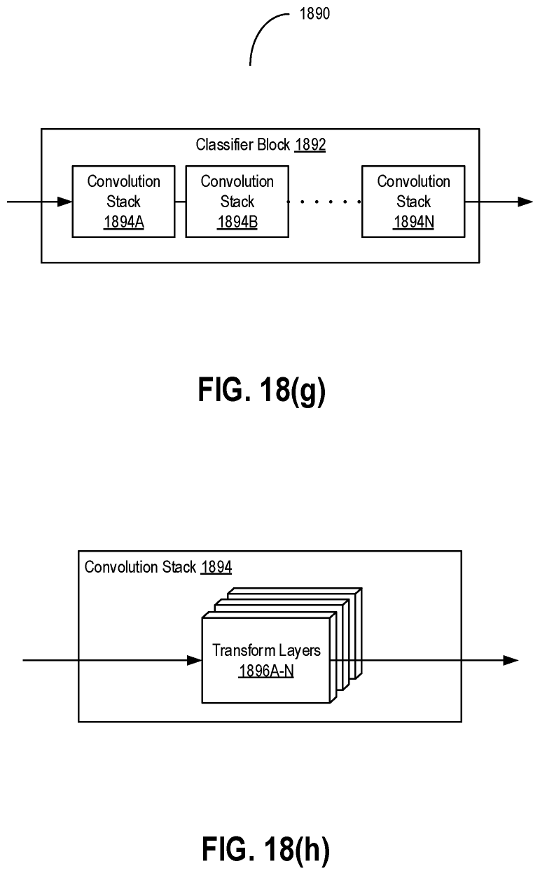

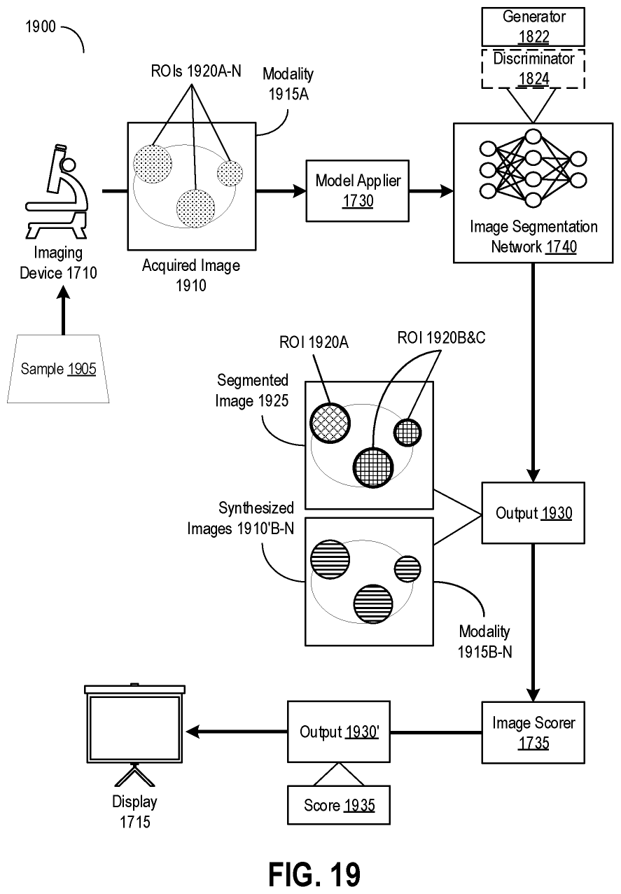

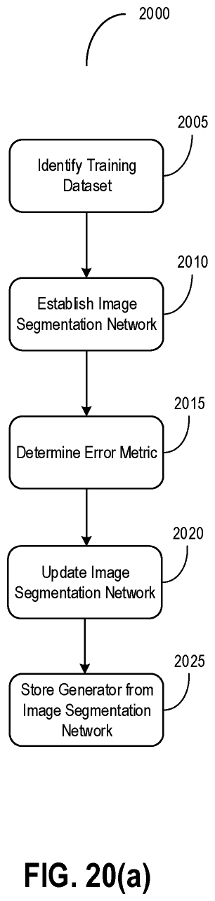

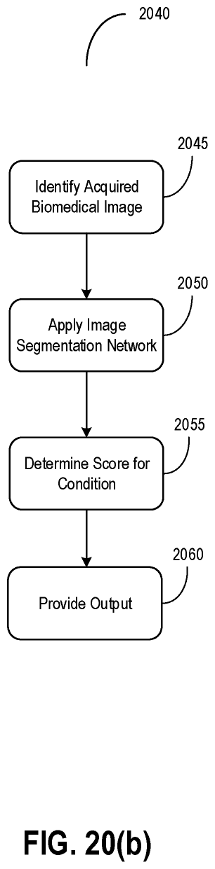

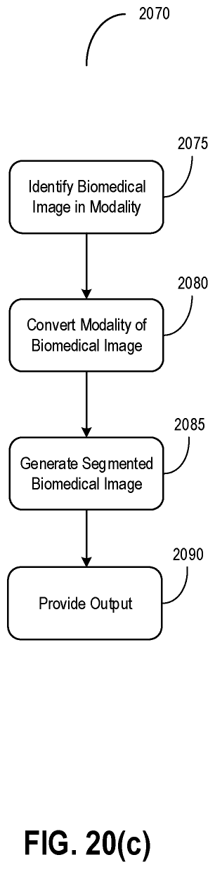

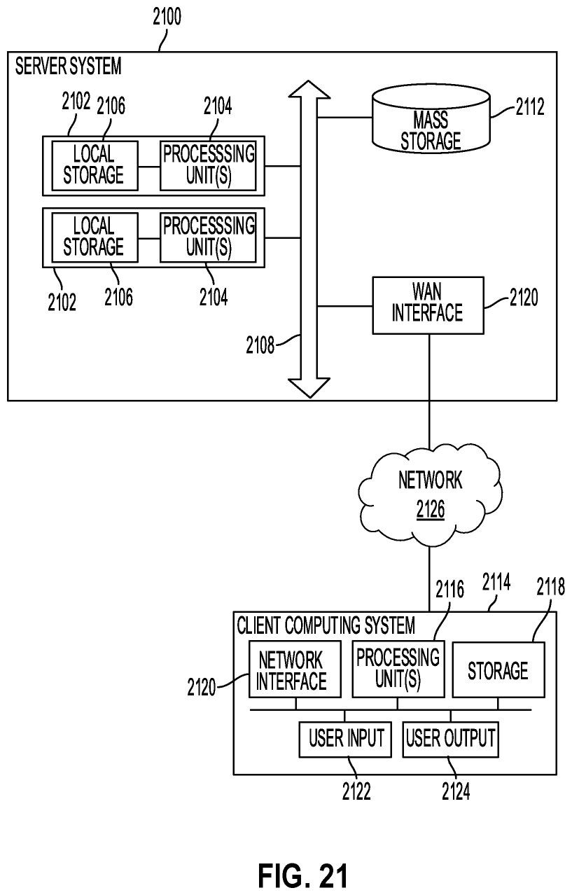

Pixel-level accuracy metrics were used for the primary evaluation, as the IHC quantification problem is formulated as cell instance segmentation/classification. However, since DeepLIIF is capable of separating the touching nuclei, a cell-level analysis of DeepLIIF was performed against cell centroid detection approaches. U CSRNet, for example, detects and classifies cells without performing cell instance segmentation. Most of these approaches use crowd-counting techniques to find cell centroids. The major hurdle in evaluating these techniques is the variance in detected cell centroids. FCRN_A , FCRN_B, Deeplab_Xeption, SC_CNN, CSR-Net, U CSRNet were also trained using the training set (the centroids of the individual cell segmentation masks are used as detection masks). Most of these approaches failed in detecting and classifying cells on the BCData testing set, and the rest detected centroids far from the ground-truth centroids. As a result, the performance of DeepLIIF (trained on the training set) was compared with these models trained on the training set of the BCDataset and the testing set of the BCData was tested. As shown in FIG. 7, even though the model was trained on a completely different dataset from the testing set, it has better performance than the detection models that were trained on the same training set of the test dataset. The results show that, unlike DeepLIIF, the detection models are not robust across different datasets, staining techniques, and tissue/cancer types.

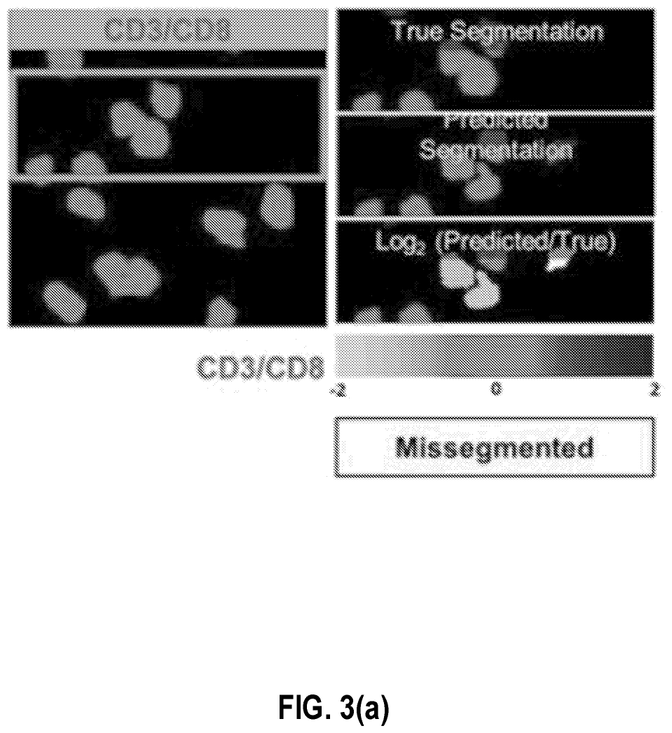

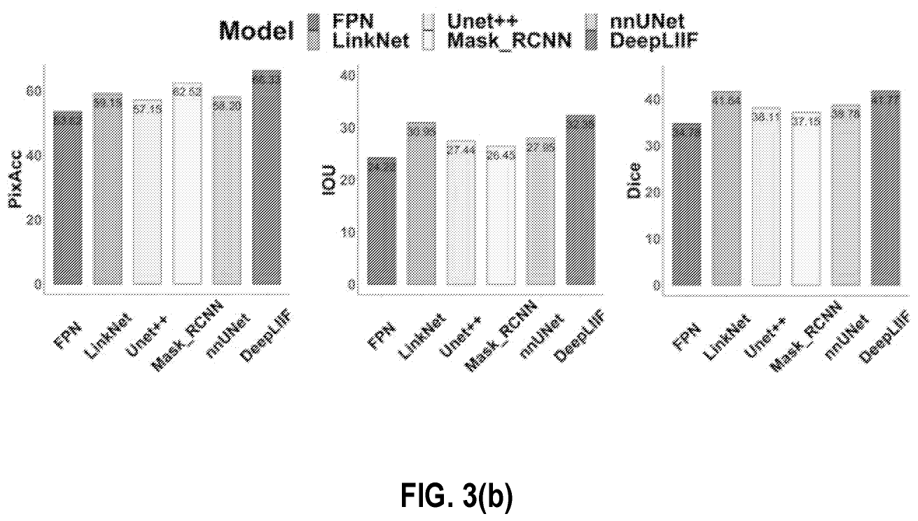

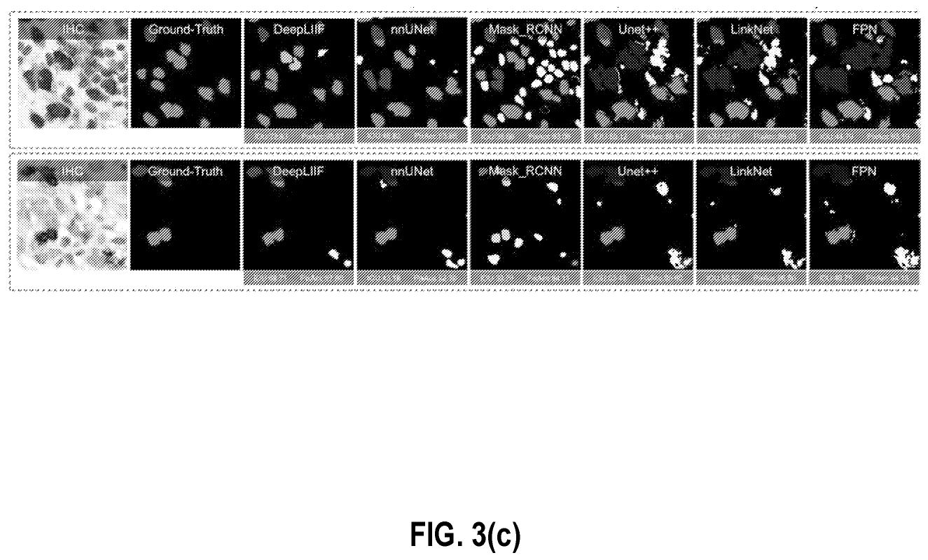

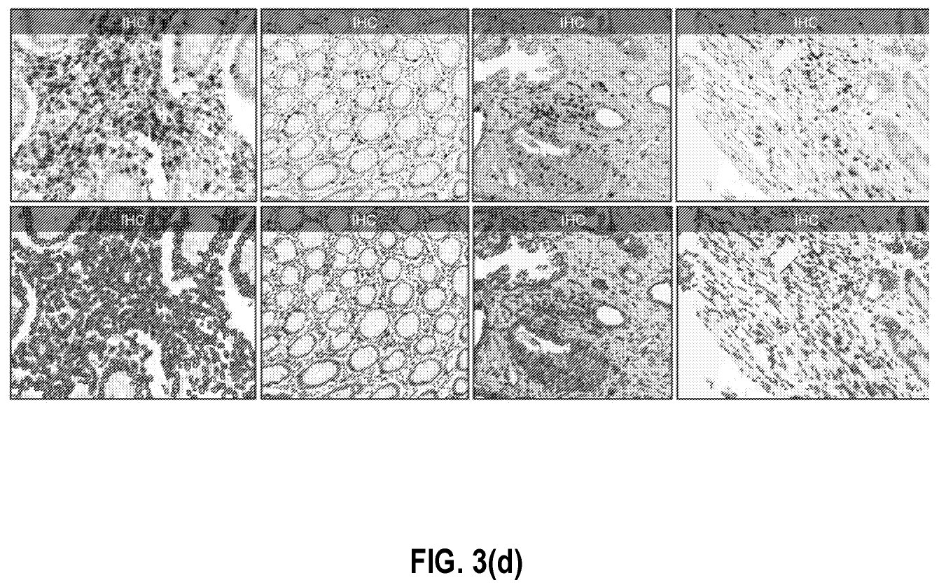

As was mentioned earlier, the model generalizes well to segment/classify cells stained with different markers, including CD3/CD8. The performance of the trained model are compared against other trained models on the training set of the NuClick dataset. The comparative analysis is shown in FIGS. 3(a)-(d). The DeepLIIF model outperformed other models on segmenting and classifying CD3/CD8+ cells (tumor-infiltrating lymphocytes or TILs) on all three metrics.

The quality of the inferred modalities was also evaluated using mean squared error (MSE) (the average squared difference between the synthetic image and the actual image) and Structural Similarity Index (SSIM) (the similarity between two image). As shown in the FIGS. 8(a)-(c), based on these metrics, DeepLIIF generates highly-realistic images. In this figure, The first two components of PCA applied to the feature vectors of synthetic and real images, calculated by the VGG16 model and then applied PCA on the calculated feature vectors, were further visualized. The results show that the synthetic image data points have the same distribution as the real image data points, confirming that the generated images by the model have the same characteristics as the real images. Original/real and DeepLIIF-Inferred modality images of two samples taken from Bladder and Lung tissues are also shown side-by-side with SSIM and MSE scores.

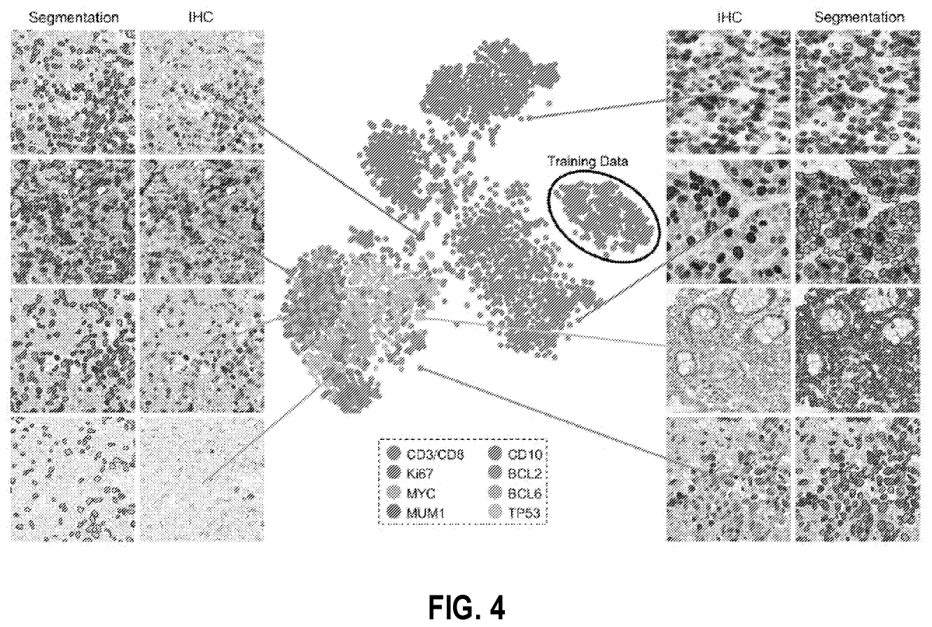

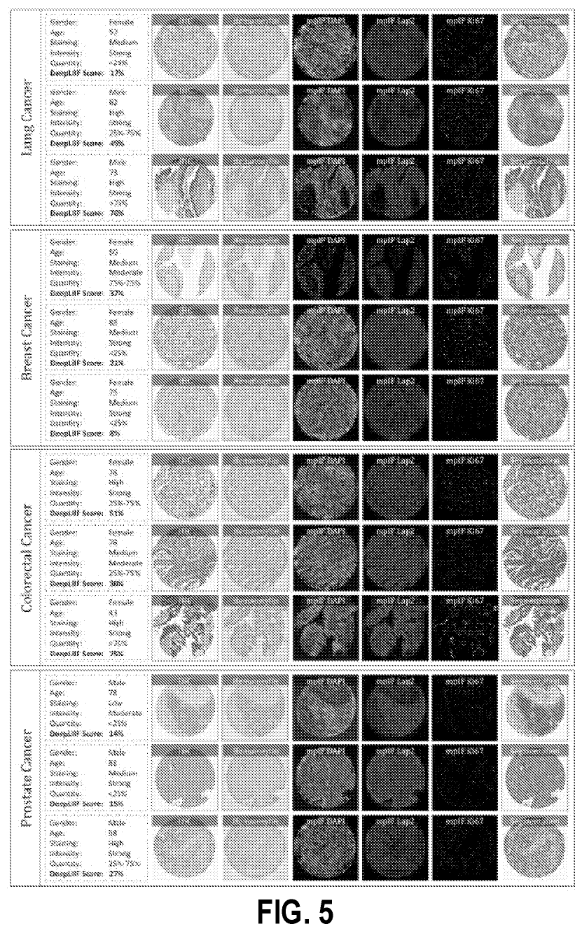

DeepLIIF was also tested on IHC images stained with eight other markers acquired with different scanners and staining protocols. The testing set includes (1) nine IHC snapshots from a digital microscope stained with Ki67 and PDL1 markers (two examples shown in FIGS. 14(a) and 14(b)), (2) testing set of LYON19 containing 441 IHC CD3/CD8 breast, colon, and prostate ROIs (no annotations) with various staining/tissue artifacts from 8 different institutions (FIG. 3(c), and FIG. 15), PathoNet IHC Ki67 breast cancer dataset, containing manual centroid annotations created from consensus of multiple pathologists, acquired in low-resource settings with microscope camera (FIG. 13), (4) Human Protein Atlas IHC Ki67 (FIGS. 5) and TP53 images (FIGS. 15), and (5) DLBCL-Morph dataset containing IHC tissue-microarrays for 209 patients stained with BCL2, BCL6, CD10, MYC, MUM1 markers (FIG. 15.) The structure of the testing dataset by applying t-distributed stochastic neighbor embedding (t-SNE) to the image styles tested on DeepLIIF is visualized in FIG. 4. The features were first extracted from each image using the VGG16 model, and principal component analysis (PCA) were applied to reduce the number of dimensions in the feature vectors. Next, the image data points based on the extracted feature vectors using t-SNE was visualized. As shown in FIG. 4, DeepLIIF is able to adapt to images with various resolutions, color and intensity distributions, and magnifications captured in different clinical settings, and successfully segment and classify the heterogeneous collection of aforementioned testing sets covering eight different IHC markers.

The performance of DeepLIIF with and without LAP2beta was also evaluated and it was found the segmentation performance of DeepLIIF with LAP2beta better than without LAP2beta (FIG. 10). LAP2beta is a nuclear envelope protein broadly expressed in normal tissues. In FIG. 9, LAP2beta immunohistochemistry reveals nuclear envelope-specific staining in the majority of cells in spleen (99.98%), colon (99.41%), pancreas (99.50%), placenta (76.47%), testis (95.59%), skin (96.74%), lung (98.57%), liver (98.70%), kidney (95.92%) and lymph node (99.86%). Placenta syncytiotrophoblast does not stain with LAP2beta, and the granular layer of skin does not show LAP2beta expression. However, the granular layer of skin lacks nuclei and is therefore not expected to express nuclear envelope proteins. A lack of consistent Lap2beta staining in the smooth muscle of blood vessel walls (not shown) is also observed.

DeepLIIF which is solely trained on IHC images stained with Ki67 marker was also tested on H&E images from the MonuSeg Dataset. As shown in FIG. 11, DeepLIIF (out-of-the-box without being trained on H&E images) was able to infer high-quality mpIF modalities and correctly segment the nuclei in these images.

### Discussion

Assessing IHC stained tissue sections is a widely utilized technique in diagnostic pathology laboratories worldwide. IHC-based protein detection in tissue with microscopic visualization is used for many purposes, including tumor identification, tumor classification, cell enumeration, and biomarker detection and quantification. Nearly all IHC stained slides for clinical care are analyzed and reported qualitatively or semi-quantitatively by diagnostic pathologists.

Several approaches have been proposed for deep learning-based stain-to-stain translation of unstained (label-free), H&E, IHC, and multiplex slides, but relatively few attempts have been made (in limited contexts) at leveraging the translated enriched feature set for cellular-level segmentation, classification or scoring. Another approached used fluorescence microscopy and histopathology H&E datasets for unsupervised nuclei segmentation in histopathology images by learning from fluorescence microscopy DAPI images. However, their pipeline incorporated CycleGAN, which hallucinated nuclei in the target histopathology domain and hence, required segmentation masks in the source domain to remove any redundant or unnecessary nuclei in the target domain. The model was also not generalizable across the two target histopathology datasets due to the stain variations, making this unsupervised solution less suitable for inferring different cell types from given H&E or IHC images. Yet another approach, on the other hand, used supervised learning trained on H&E and co-registered single-channel pancytokeratin IF for four pancreatic ductal adenocarcinomas (PDAC) patients to infer pancytokeratin stain for given PDAC H&E image. Another approach used a supervised learning method trained on H&E, and co-registered IHC PHH3 DAB slides for mitosis detection in H&E breast cancer WSIs. Another approach used co-registered H&E and special stains for kidney needle core biopsy sections to translate given H&E image to special stains. In essence, there are methods to translate between H&E and IHC but none for translating between IHC and mpIF modalities. To focus on immediate clinical application, the cellular information is to be accentuated or disambiguated in low-cost IHCs (using a higher-cost and more informative mpIF representation) to improve the interpretability for pathologists as well as for the downstream analysis/algorithms.

By creating a multitask deep learning framework referred to as DeepLIIF, a unified solution is provided to nuclear segmentation and quantification of IHC stained slides. DeepLIIF is automated and does not require annotations. In contrast, most commercial platforms use a time-intensive workflow for IHC quantification, which involves user-guided (a) IHC-DAB deconvolution, (b) nuclei segmentation of hematoxylin channel, (c) threshold setting for the brown DAB stain, and (d) cell classification based on the threshold. A simpler workflow given an IHC input is presented, different modalities along with the segmented and classified cell masks are generated. The multitask deep learning framework performs IHC quantification in one process and does not require error-prone IHC deconvolution or manual thresholding steps. A single optimizer may be used for all generators and discriminators that improves the performance of all tasks simultaneously. Unique to this model, DeepLIIF is trained by generating registered mpIF, IHC, and hematoxylin staining data from the same slide with the inclusion of nuclear envelope staining to assist in accurate segmentation of adjacent and overlapping nuclei.

Formulating the problem as cell instance segmentation/classification rather than a detection problem helps to move beyond the reliance on crowd counting algorithms and towards more precise boundary delineation (semantic segmentation) and classification algorithms. DeepLIIF was trained for multi-organ, stain invariant determination of nuclear boundaries and classification of subsequent single-cell nuclei as positive or negative for Ki67 staining detected with the 3,3′-Diaminobenzidine (DAB) chromogen. Subsequently, it is determined that DeepLIIF accurately classified all tested nuclear antigens as positive or negative.

Surprisingly, DeepLIIF is often capable of accurate cell classification of non-nuclear staining patterns using CD3, CD8, BCL2, PDL1, and CD10. The success of the DeepLIIF classification of non-nuclear markers is at least in part dependent on the location of the chromogen deposition. BCL2 and CD10 protein staining often show cytoplasmic chromogen deposition close to the nucleus, and CD3 and CD8 most often stain small lymphocytes with scant cytoplasm whereby the chromogen deposition is physically close to the nucleus. DeepLIIF is slightly less accurate in classifying PDL1 staining (FIG. 14) and, notably, PDL1 staining is more often membranous staining of medium to large cells such as tumor cells and monocyte-derived cell lineages where DAB chromogen deposition is physically further from the nucleus. Since DeepLIIF was not trained for non-nuclear classification, it is anticipated that further training using non-nuclear markers will rapidly improve their classification with DeepLIIF.

DeepLIIF, handling of H&E images (FIG. 11), was the most pleasant surprise where the model out-of-the-box learnt to even separate the H&E images into hematoxylin and (instead of mpIF protein marker) eosin stains. The nuclei segmentations were highly precise. This opens up lot of interesting avenues to potentially drive whole slide image registration of neighboring H&E and IHC sections by converting these to a common domain (clean mpIF DAPI images) and then performing deformable image registration.

For IHC images, the performance of DeepLIIF is purposely assessed for the detection of proteins currently reported semi-quantitatively by pathologists with the goal of facilitating the transition to quantitative reporting if deemed appropriate. This can be extended to assess the usability of Ki67 quantification in tumors with more unusual morphologic features such as sarcomas. The approach will also be extended to handle more challenging membranous/cytoplasmic markers such as PDL1, Her2, etc as well as H&E and multiplex IHC staining (without requiring any manual/weak annotations for different cell types). Finally, additional mpIF tumor and immune markers are incorporated into DeepLIIF for more precise phenotypic IHC quantification such as for distinguishing PDL1 expression within tumor versus macrophage populations.

The present disclosure provides a universal, multitask model for both segmenting nuclei in IHC images and recognizing and quantifying positive and negative nuclear staining. Importantly, described is a modality where training data from higher-cost and higher-dimensional multiplex imaging platforms improves the interpretability of more widely-used and lower-cost IHC.

### Methods

Training Data. To train DeepLIIF, a dataset of lung and bladder tissues containing IHC, hematoxylin, mpIF DAPI, mpIF Lap2, and mpIF Ki67 of the same tissue scanned using ZEISS Axioscan are used. These images were scaled and co-registered with the fixed IHC images using affine transformations, resulting in 1667 registered sets of IHC images and the other modalities of size 512 512. 709 sets were randomly selected for training, 358 sets were randomly selected for validation, and 600 sets were randomly selected for testing the model.

Ground-truth Classified Segmentation Mask. To create the ground-truth segmentation mask for training and testing the model, the interactive deep learning ImPartial annotations framework is used. Given mpIF DAPI images and few cell annotations, this framework auto-thresholds and performs cell instance segmentation for the entire image. Using this framework, nuclear segmentation masks may be generated for each registered set of images with precise cell boundary delineation. Finally, using the mpIF Ki67 images in each set, the segmented cells may be classified in the segmentation mask, resulting in 9180 Ki67 positive cells and 59000 Ki67 negative cells. Examples of classified segmentation masks from the ImPartial framework are shown in FIGS. 1 and 2. The green boundary around the cells are generated by ImPartial, and the cells are classified into red (positive) and blue (negative) using the corresponding mpIF Ki67 image. If a segmented cell has any representation in the mpIF Ki67 image, the image may be classified as positive (red color), otherwise, the image may be classified as negative (blue color).

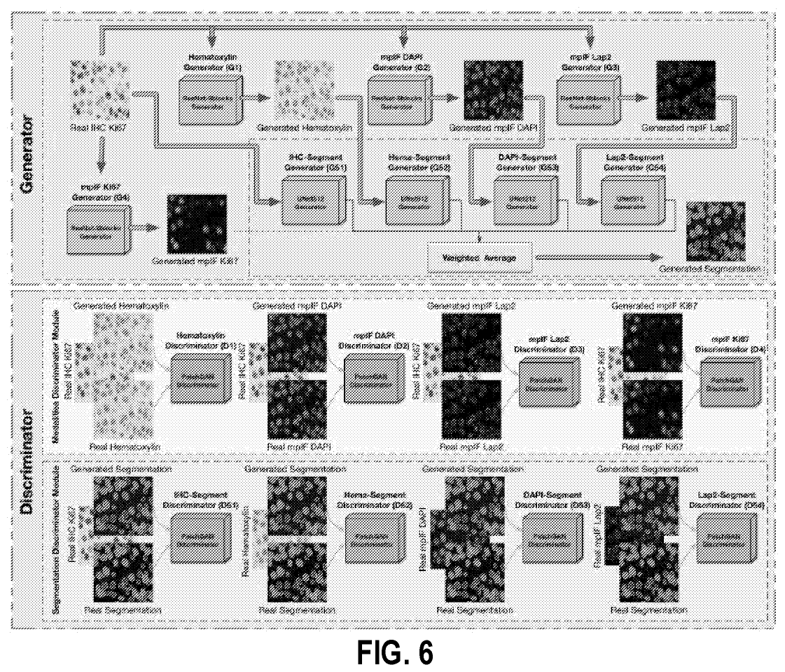

Objective. Given a dataset of IHC+Ki67 RGB images, the objective is to train a model f (⋅) that maps an input image to four individual modalities, including Hematoxylin channel, mpIF DAPI, mpIF Lap2, and mpIF Ki67 images, and using the mapped representations, generate the segmentation mask. Presented herein is a framework, as shown in FIG. 6 that performs two tasks simultaneously. First, the translation task translates the IHC+Ki67 image into four different modalities for clinical interpretability as well as for segmentation. Second, a segmentation task generates a single classified segmentation mask from the IHC input and three of the inferred modalities by applying a weighted average and coloring cell boundaries green, positive cells red, and negative cells blue.

cGANs may be used to generate the modalities and the segmentation mask. cGANs are made of two distinct components, a generator and a discriminator. The generator learns a mapping from the input image x to output image y, G: x→y. The discriminator learns to the paired input and output of the generator from the paired input and ground truth result. Eight generators are defined to produce four modalities and segmentation masks that cannot be distinguished from real images by eight adversarially trained discriminators (trained to detect fake images from the generators).

Translation. Generators Gₜ_{₁}, Gₜ_{₂}, Gₜ_{₃}, and Gₜ_{₄}, produce hematoxylin, mpIF DAPI, mpIF Lap2, and mpIF Ki67 images from the input IHC image, respectively ((Gₜ_{ᵢ}: xᵢ→yᵢ, where i=1, 2, 3, 4). The discriminator D, is responsible for discriminating generated images by generators Gₜ_{ᵢ}. The objective of the conditional GAN for the image translator tasks are defines as follows:

L_{tGAN}(Gₜ_{ᵢ},Dₜ_{ᵢ})= [symbol] _{x,t}_{ᵢ}[log Dₜ_{ᵢ}(x,yᵢ)]+ [symbol] _{x,y}_{ᵢ}[log(1−Dₜ_{ᵢ}(x,Gₜ_{ᵢ}(x)))] (1)

Smooth L1 loss (Huber loss) is used to compute the error between the predicted value and the true value, since it is less sensitive to outliers compared to L2 loss and prevents exploding gradients while minimizing blur. It is defined as:

$${L}_{L 1} ( G ) = {𝔼}_{x , y} [ {smooth}_{L 1} ( y - G ( x ) ) ] \qquad ( 2 )$$

$$where$$

$${smooth}_{L 1} ( a ) = \{ \begin{matrix}o \text{.5} {a}^{2} & if \vert a \vert < 0.5 \\ \vert a \vert - 0.5 & otherwise\end{matrix} \qquad ( 3 )$$

The objective loss function of the translation task is:

L_{T}(Gₜ, Dₜ)=ΣL_{tGAN}(Gₜ_{ᵢ}, Dₜ_{ᵢ})+λL_{L1}(Gₜ_{ᵢ}) i=1˜5 (4)

where λ controls the relative importance of two objectives.

Segmentation/Classification. The segmentation component consists of five generators G_{S}_{₁}, G_{S}_{₂}, G_{S}_{₃}, G_{S}_{₄}, and G_{S}_{₅}, producing five individual segmentation masks from the original IHC, inferred hematoxylin image (Gₜ_{₁}), inferred mpIF DAPI (Gₜ_{₂}), inferred mpIF Lap2(Gₜ_{₃}), and inferred mpIF marker(Gₜ_{₄}), G_{S}_{ᵢ}=:zᵢ→yₛ_{ᵢ} where i=1, 2, 3, 4, 5. The final segmentation mask is created by averaging the five generated segmentation masks by G_{S}_{₁}, using pre-defined weights, S(zᵢ)=Σₙ₌₁⁵wsᵢ×Gₛ_{ᵢ}(zᵢ), where wₛ_{ᵢ} are the pre-defined weights. The discriminators D_{S}_{ᵢ} are responsible for discriminating generated images by generators G_{S}_{₁}.

In this task, LSGAN loss function may be used, since it solves the problem of vanishing gradients for the segmented pixels on the correct side of the decision boundary, but far from the real data, resulting in a more stable boundary segmentation learning process. The objective of the conditional GAN may be defined for segmentation/classification task as follows:

$${L}_{sGAN} ( {D}_{S} ) = \sum ( \frac{1}{2} {𝔼}_{{z}_{i} , {y}_{{s}_{i}}} [ {( {D}_{{S}_{i}} ( {z}_{i} , {y}_{{s}_{i}} ) - 1 )}^{2} ] \qquad ( 5 )$$

$$i = 1 ∼ 5$$

$$+ \frac{1}{2} {𝔼}_{{z}_{i} , {y}_{{s}_{i}}} [ {( {D}_{{S}_{i}} ( {z}_{i} , S ( {z}_{i} ) ) )}^{2} ] )$$

$${L}_{sGAN} ( {D}_{S} ) = \sum ( \frac{1}{2} {𝔼}_{{z}_{i} , {y}_{{s}_{i}}} [ {( {D}_{{S}_{i}} ( {z}_{i} , S ( {z}_{i} ) ) - 1 )}^{2} ]$$

$$i = 1 ∼ 5$$

For this task, smooth L1 loss may also be used. The objective loss function of the segmentation/classification task is:

L_{S}(S, Dₛ)=L_{sGAN}(S, Dₛ)+λL_{L1}(S) (6)

Final Objective. The final objective is:

L(Gₜ, Dₜ,S,D_{S})=Lₜ[Gₜ, Dₜ]+L_{S}(S, D_{S} (7)

Generator. Two different types of generators, ResNet-9blocks generator may be used for producing modalities and UNet generator for creating segmentation mask.

ResNet-9blocks Generator. The generators responsible for generating modalities including hematoxylin, mpIF DAPI and mpIF Lap2 starts with a convolution layer and a batch normalization layer followed by Rectified Linear Unit (ReLU) activation function, 2 downsampling layers, 9 residual blocks, 2 upsampling layers, and a covolutional layer followed by a tanh activation function. Each residual block consists of two convolutional layers with the same number of output channels. Each convolutional layer in the residual block is followed by a batch normalization layer and a ReLU activation function. Then, these convolution operations are skipped and the input is directly added before the final ReLU activation function.

U-Net Generator. For generating the segmentation masks, the generator may be used, using the general shape of U-Net with skip connections. The skip connections are added between each layer i and layer n−i where n is the total number of layers. Each skip connection concatenates all channels at layer i with those at layer n−i.

Markovian discriminator (PatchGAN). To address high-frequencies in the image, a PatchGAN discriminator that only penalizes structure at the scale of patches may be used. It classifies each N×N patch in an image as real or fake. This fully convolutional discriminator may be run across the image, averaging all responses to provide the final output of D.

Optimization. To optimize the network, the approach may be used to alternate between one gradient descent step on D and one step on G. In all defined tasks (translation, classification, and segmentation), the network generates different representations for the same cells in the input meaning all tasks have the same endpoint. Therefore, a single optimizer may be used for all generators and a single optimizer for all discriminators. Using this approach, optimizing the parameters of a task with a more clear representation of cells improves the accuracy of other tasks since all these task are optimized simultaneously.

Synthetic Data Generation. It was found that the model consistently failed in regions with dense clusters of IHC positive cells due to the absence of similar characteristics in the training data. To infuse more information about the clustered positive cells into the model, a novel GAN-based model may be developed for the synthetic generation of IHC images using coregistered data. The model takes as input Hematoxylin channel, mpIF DAPI image, and the segmentation mask and generates the corresponding IHC image (FIGS. 12(a) and 12(b)). The model converts the Hematoxylin channel to grayscale to infer more helpful information such as the texture and discard unnecessary information such as color. The Hematoxylin image guides the network to synthesize the background of the IHC image by preserving the shape and texture of the cells and artifacts in the background. The DAPI image assists the network in identifying the location, shape, and texture of the cells to better isolate the cells from the background. The segmentation mask helps the network specify the color of cells based on the type of the cell (positive cell: a brown hue, negative: a blue hue). In the next step, synthetic IHC images may be generated with more clustered positive cells. To do so, the segmentation mask may be changed by choosing a percentage of random negative cells in the segmentation mask (called Neg-to-Pos) and converting these into positive cells. New IHC images may be syntheisized by setting Neg-to-Pos to 50%, 70%, and 90%. DeepLIIF was retrained with the new dataset, containing original images and these synthesized ones, which resulted in improvement of Dice score by 6.57%, IOU by 7.08%, AJI by 5.53%, and Pixel Accuracy by 2.49%.

Training Details. The model is trained from scratch, using a learning rate of 0.0002 for 100 epochs, and linearly decay the rate to zero over the next 100 epochs. The weights were initialized from a Gaussian distribution N (0, 0.02). λ=100 is set accordingly to give more weight to L1 loss. Batch normalization is used in the main model. Another solver was used with a batch size of 1. Tree-structured Parzen Estimator (TPE) is used for hyperparameter optimization, and the L1 loss (Least Absolute Deviations) is chosen as the evaluation metric to be minimized. The L1 loss is computed for the segmentation mask generated by the model and try to minimize the L1 loss using the TPE approach. Various hyperparameters are optimized, including the network generator architecture, the discriminator architecture, the number of layers in the discriminator while using layered architecture, the number of filters in the generator and discriminator, normalization method, initialization method, learning rate, and learning policy, λ, and the GAN loss function, segmentation mask generators weights with diverse options for each of them.

Based on the hyperparameter optimization, the following predefined weights (wsᵢ) were set for individual modalities to generate the final segmentation mask: weight of segmentation mask generated by original IHC image (ws₁)=0.25, Hematoxylin channel (ws₂)=0.15, mpIF DAPI (ws₃)=0.25, mpIF Lap2 (ws₄)=0.1, and mpIF protein marker image (ws₅)=0.25. The cell type (positive or negative) is classified using the original IHC image (where brown cells are positive and blue cells are negative) and the mpIF protein marker image (which only shows the positive cells). Therefore, to have enough information on the cell types, these two representations are assigned 50% of the total weight with equal contribution. The mpIF DAPI image contains the representation of the cell where the background and artifacts are removed. Since this representation has the most useful information on the cell shape, area, and boundaries, it was assigned 25% of the total weight in creating the segmentation mask. The mpIF Lap2 image is generated from the mpIF DAPI image and it contains only the boundaries on the cells. Even though it has more than 90% coverage, it still misses out on cells, hence 15% of the total weight makes sense. With this weightage, if there is any confusing information in the mpIF DAPI image, it does not get infused into the model by a large weight. Also, by giving less weight to the Lap2, the final segmentation probability of the cells not covered by Lap2 is increased. The Hematoxylin image has all the information, including the cells with lower intensities, the artifacts, and the background. Since this image shares the background and artifacts information with the IHC image and the cell information with the mpIF DAPI image, it is given less weight to decrease the probability of artifacts being segmented and classified as cells.

One of the challenges in GANs is the instability of its training. Spectral normalization, a weight normalization technique, is used to stabilize the training of the discriminator. Spectral normalization stabilizes the training of discriminators in GANs by re-scaling the weight tensor with spectral norm a of the weight matrix calculated using the power iteration method. If the dimension of the weight tensor is greater than 2, it is reshaped to 2D in the power iteration method to get the spectral norm. The model is first trained using spectral normalization on the original dataset. The spectral normalization could not significantly improve the performance of the model. The original model achieved Dice score of 61.57%, IOU 46.12%, AJI 47.95% and Pixel Accuracy 91.69% whereas the model with spectral normalization achieved a Dice score of 61.57%, IOU of 46.17%, AJI of 48.11% and Pixel Accuracy of 92.09%. In another experiment, the model with spectral normalization is trained on the new dataset containing original as well as the generated synthetic IHC images. The Dice score, IOU, and Pixel accuracy of the model trained using spectral normalization dropped from 68.15% to 65.14%, 53.20% to 51.15%, and 94.20% to 94.18%, respectively, while the AJI improved from 53.48% to 56.49%. As the results show, the addition of the synthetic images in training improved the model's performance across all metrics.

To increase the inference speed of the model, many-to-one approach are experimented with for segmentation/classification task to decrease the number of generators to one. In this approach, there may be four generators and four discriminators for inferring the modalities but use one generator and one discriminator (instead of five) for segmentation/classification task, trained on the combination of all inferred modalities. This model is first trained with the original dataset. Compared to the original model with five segmentation generators, the Dice score, IOU, AJI, and Pixel Accuracy dropped by 12.13%, 10.21%, 12.45%, and 3.66%, respectively. In another experiment, the model with one segmentation generator is trained on the new dataset including synthetic images. Similar to the previous experiment, using one generator instead of five independent generators deteriorated the model's performance in terms of Dice score by 7%, IOU by 6.49%, AJI by 3.58%, and Pixel Accuracy by 0.98%. It is observed that similar to the original model, the addition of synthetic IHC images in the training process with one generator could increase the Dice score from 49.44% to 61.13%, the IOU from 35.91% to 46.71%, the AJI from 35.50% to 49.90%, and Pixel Accuracy from 88.03 to 93.22%, while reducing the performance drop, compared to the original model; this was still significantly less than the best performance from the multi-generator configuration, as shown above, Dice score 68.15%, IOU 53.20%, AJI 53.48%, and Pixel Accuracy 94.20%.

Testing Details. The inference time of the model for a patch of 512×512 is 4 seconds. To infer modalities and segment an image larger than 512×512, the image is tiled into overlapping patches. The tile size and overlap size can be given by the user as an input to the framework. The patches containing no cells are ignored in this step, improving the inference time. Then, the tiles are run through the model. The model resizes the given patches to 512 for inference. In the final step, tiles are stitched using the given overlap size to create the final inferred modalities and the classified segmentation mask. It takes about 10 to 25 minutes (depending on the percentage of cell-containing region, the WSI magnification level, user-selected tile size and overlap size) to infer the modalities and the classified segmentation mask of a WSI with size of 1000×10000 with 40× magnification.

Ablation Study. DeepLIIF infers four modalities to compute the segmentation/classification mask of an IHC image. An ablation study is performed on each of these four components. The goal of this experiment is to investigate if the performance improvements are due to the increased ability of each task-specific network to share their respective features. In each experiment, the model is trained with three modalities, each time removing a modality to study the accuracy of the model in absence of that modality. All models are tested on the BC Dataset of 164 images with size 512 512. The results show that the original model (with all modalities) with Dice score 65.14%, IOU 51.15%, AJI 56.49% and Pixel Accuracy of 94.20% outperforms the model without Hematoxylin modality with Dice score 62.86%, IOU 47.68%, AJI 50.10% and Pixel Accuracy 92.43%, model without mpIF DAPI with Dice score 62.45%, IOU 47.13%, AJI 50.38% and Pixel Accuracy 92.35%, model without mpIF Lap2 with Dice score 61.07%, IOU 45.71%, AJI 49.14%, and Pixel Accuracy 92.16%, and model without mpIF protein marker with Dice score 57.92%, IOU 42.91%, AJI 47.56%, and Pixel Accuracy 91.81%. The mpIF Lap2 is important for splitting overlapping cells and detecting boundaries (the model without mpIF Lap2 has the lowest AJI score). Moreover, mpIF Lap2 is the only modality among the four that clearly outlines the cells in regions with artifacts or noise. The model without mpIF protein marker image has the worst Pixel Accuracy and Dice score, showing its clear importance in cell classification. The mpIF DAPI image guides the model in predicting the location of the cells, given the drop in Pixel Accuracy and AJI score. Hematoxylin image on the other hand seems to make the least difference when removed, though it helps visually (according to two trained pathologists) by providing a separated hematoxylin channel from the IHC (Hematoxylin+DAB) input.

### B. Systems and Methods for Quantifying Conditions on Biomedical Images and Converting Staining Modalities in Biomedical Images

Referring now to FIG. 17, depicted is a block diagram of a system 1700 for quantifying conditions in biomedical images. In overview, the system 1700 may include at least one image quantification system 1705, at least one imaging device 1710, and at least one display 1715 communicatively coupled with one another via at least one network 1720. The image quantification system 1705 may include at least one model trainer 1725, at least one model applier 1730, at least one image scorer 1735, at least one image segmentation network 1740, and at least one database 1745. The database 1745 may store, maintain, or otherwise include at least one training dataset 1750. Each of the components in the system 1700 as detailed herein may be implemented using hardware (e.g., one or more processors coupled with memory) or a combination of hardware and software as detailed herein in Section C. Each of the components in the system 1700 may implement or execute the functionalities detailed herein, such as those described in Section A.

In further detail, the image quantification system 1705 itself and the components therein, such as the model trainer 1725, the model applier 1730, the image scorer 1735, and the image segmentation network 1740, may have a training mode and a runtime mode (sometimes herein referred to as an evaluation or inference mode). Under the training mode, the image quantification system 1705 may invoke the model trainer 1725 to train the image segmentation network 1740 using the training dataset 1750. Under the runtime, the image quantification system 1705 may invoke the model applier 1730 to apply the image segmentation network 1740 to new incoming biomedical images.

Referring now to FIG. 18(a), depicted is a sequence diagram of a process 1800 of training the image segmentation network 1740 in the system for quantifying conditions in biomedical images. The process 1800 may correspond to or include the operations performed by the image quantification system 1705 under the training mode. Under process 1800, the model trainer 1725 executing on the image quantification system 1705 may initialize, train, and establish the image segmentation network 1740 using the training dataset 1750. The model trainer 1725 may access the database 1745 to retrieve, obtain, or otherwise identify the training dataset 1750. The training dataset 1750 may identify or include a set of unlabeled images 1802A-N (hereinafter generally referred to as unlabeled images 1802) and a corresponding set of labeled images 1804A-N (hereinafter generally referred to as labeled images 1804). From the training dataset 1750, the model trainer 1725 may identify each unlabeled image 1802 and an associated labeled image 1804. Each unlabeled image 1802 may be an originally acquired biomedical image and a corresponding labeled image 1804 may be a segmented version of the same biomedical image.

The set of unlabeled images 1802 and the set of labeled images 1804 (sometimes herein generally referred to as biomedical images) may be acquired or derived from at least one sample 1806 using microscopy techniques. The sample 1806 may be a tissue sample obtained from a human or animal subject. The tissue sample may be from any part of the subject, such as a muscle tissue, a connective tissue, an epithelial tissue, or a nervous tissue in the case of a human or animal subject. In some embodiments, the set of unlabeled images 1802 or the set of labeled images 1804 may be acquired or derived using immunostaining techniques (e.g., immunofluorescence) in accordance with a corresponding set of staining modalities 1808A-N (hereinafter generally referred to as staining modalities 1808). Each staining modality 1808 may correspond to a stain selected to identify a particular antigen, protein, or other biomarker in the sample 1806. The biomarkers may include DAPI, Lap2, Ki67, BCL2, BCL6, MUM1, MYC, TP53, CD3/CD8, and CD10, among others.

In some embodiments, the set of unlabeled images 1802 or the set of labeled images 1804 may be acquired in accordance with a histopathological image preparer using one or more staining modalities 1808. Each of the set of unlabeled images 1802 or the set of labeled images 1804 may be a histological section with a stain in accordance with the staining modality 1808. For example, the biomedical image in the set of unlabeled images 1802 or the set of labeled images 1804 may be a whole slide image (WSI) with a stain. The stain of the staining modality 1808 may include, for example, hematoxylin and eosin (H&E) stain, hemosiderin stain, a Sudan stain, a Schiff stain, a Congo red stain, a Gram stain, a Ziehl-Neelsen stain, a Auramine—rhodamine stain, a trichrome stain, a Silver stain, and Wright's Stain, among others. The set of unlabeled images 1802 or the set of labeled images 1804 may include biomedical images acquired in accordance with a histopathological image preparer and biomedical images derived using immunostaining techniques.

Each unlabeled image 1802 may be associated with a corresponding labeled image 1804 in accordance with the same modality 1808 for the same sample 1806. For example, a pair of a unlabeled image 1802A and a labeled image 1804A may be acquired from the sample 1806 using the stain modality 1808A for DAPI, while another pair of a unlabeled image 1802B and a labeled image 1804B may be derived from the same sample 1806 using the stain modality 1808B for CD/CD8. The sample 1806 from which the unlabeled image 1802 and the labeled image 1804 is derived may include one or more objects with conditions (e.g., cell nuclei in the tissue with the biomarkers). The staining modality 1808 may visually differentiate such objects, and the objects in the sample 1806 may appear or be represented by one or more regions of interest (ROIs) 1810A-N (hereinafter generally referred to as ROIs 1810). The set of ROIs 1810 may be associated with the condition (e.g., presence or lack thereof) of the corresponding objects in the sample 1806. The condition may include, for example, presence or absence of tumor or lesion in the cell nuclei depicted in the input biomedical image. Both the unlabeled image 1802 and the corresponding labeled image 1804 may include ROIs 1810. The unlabeled image 1802 may lack any identification or annotation defining the ROIs 1810. On the other hand, the labeled image 1804 associated with the labeled image 1804 may identify the ROIs 1810 or have an annotation identifying the ROIs 1810 (e.g., using pixel coordinates).

In training the image segmentation network 1740, the model applier 1730 executing the image quantification system 1705 may apply the set of unlabeled images 1802 and the labeled images 1804 from the training dataset 1750 to the image segmentation network 1740. The image segmentation network 1740 may have a set of kernels (sometimes herein referred to as parameters or weights) to process inputs and to produce outputs. The set of kernels for the image segmentation network 1740 may be arranged, for example, in accordance with a generative adversarial network (GAN) using the architecture as detailed herein in conjunction with FIG. 6. To apply, the model applier 1730 may feed each unlabeled image 1802 and labeled image 1804 as input into the image segmentation network 1740. The model applier 1730 may process the inputs in accordance with the set of kernels defined in the image segmentation network 1740 to generate at least one output 1812. Details of the architecture of the image segmentation network 1740 are described herein below in conjunction with FIGS. 18(b)-(f).

Referring now to FIG. 18(b), depicted is a block diagram of an architecture 1820 for the image segmentation network 1740 in the system 1700 for quantifying conditions in biomedical images. In accordance with the architecture 1820, the image segmentation network 1740 may include at least one generator 1822 and at least one discriminator 1824, among others. The generator 1822 and the discriminator 1824 of the image segmentation network 1740 may be in accordance with a generative adversarial network (GAN) (e.g., as depicted), a variational auto-encoder, or other unsupervised or semi-supervised model, among others. The generator 1822 may include at least one modality synthesizer 1826 and at least one image segmenter 1828, among others. The discriminator 1824 may include at least one synthesis classifier 1830 and at least one segmentation classifier 1832, among others. The image segmentation network 1740 may include one or more inputs and one or more outputs. The inputs and the outputs of the image segmentation network 1740 may be related to one another via the set of kernels arranged across the generator 1822 and the discriminator 1824.

In the generator 1822, the modality synthesizer 1826 may receive, retrieve, or otherwise identify at least one of the unlabeled images 1802 in one of the staining modalities 1808 as input. For example as depicted, the modality synthesizer 1826 may receive a first unlabeled image 1802A of a first staining modality 1808A as input. In accordance with the set of kernels, the modality synthesizer 1826 may process the input unlabeled image 1802A in the original modality. From processing, the modality synthesizer 1826 may determine, produce, or otherwise generate a set of synthesized images 1802′B-N (hereinafter generally referred to as synthesized images 1802′) in other staining modalities 1808. The staining modalities 1808 of the set of synthesized images 1802′ may differ from the staining modality 1808 of the input unlabeled image 1802. The output set of synthesized images 1802′ may be fed as inputs to the image segmenter 1828 of the generator 1822 and fed forward as one of the inputs to the synthesis classifier 1830 in the discriminator 1824. The output set of synthesized images 1802′ may also be provided as one of the outputs 1812 of the overall image segmentation network 1740.

The image segmenter 1828 may receive, retrieve, or otherwise identify the unlabeled image 1802 and the set of synthesized images 1802′ generated by the modality synthesizer 1826 as inputs. For each of the images, the image segmenter 1828 may process the input according to the set of kernel parameters. By processing, the image segmenter 1828 may determine, produce, or otherwise generate a set of segmented images 1804′A-N (hereinafter generally referred to as segmented images 1804′) for the corresponding set of inputs. Each segmented image 1804′ may define or identify the ROIs 1810 in a corresponding input image (e.g., the unlabeled image 1802A or the set of synthesized images 1802′B-N) in the associated staining modality 1808. In some embodiments, the segmented image 1804′ may identify the ROIs 1810 by presence or absence of the associated condition. In some embodiments, the image segmenter 1828 may determine or generate an aggregated segmented image based on a combination (e.g., weighted average) of the set of segmented images 1804′. The output of segmented images 1804′ may be fed forward as one of the inputs to the segmentation classifier 1832. The output from the image segmenter 1828 may also be provided as one of the outputs 1812 of the overall image segmentation network 1740. The details of the generator 1822 are further discussed herein in conjunction with FIGS. 18(c)-(e).

In the discriminator 1824, the synthesis classifier 1830 may receive, retrieve, or otherwise identify the unlabeled images 1802 of the training dataset 1750 and the set of synthesized images 1802′ generated by the modality synthesizer 1826. Each unlabeled image 1802 from the training dataset 1750 may correspond to a synthesized image 1802′ for the same staining modality 1808. For each staining modality 1808, one of the unlabeled image 1802 or the synthesized image 1802′ may be fed into the synthesis classifier 1830 as input. By processing, the synthesis classifier 1830 may determine whether the input is from the unlabeled image 1802 (sometimes herein referred to in this context as the real image) or the synthesized image 1802′ (sometimes herein referred to in this context as the fake image) for the same staining modality 1808. Based on the determination, the synthesis classifier 1830 may determine or generate a modality classification result 1834A-N (hereinafter generally referred to as a modality classification result 1834). The set of modality classification results 1834 may correspond to the set of staining modalities 1808 for the input images, such as the unlabeled image 1802 or the synthesized image 1802′. The modality classification result 1834 may indicate whether the input to the synthesis classifier 1830 is the unlabeled image 1802 or the synthesized image 1802′. The output of the synthesis classifier 1830 may be provided as one of the outputs 1812 of the overall image segmentation network 1740.

The segmentation classifier 1832 may receive, retrieve, or otherwise identify the labeled images 1804 of the training dataset 1750 and the set of segmented images 1804′ generated by the image segmenter 1828. Each labeled image 1804 from the training dataset 1750 may correspond to a segmented image 1804′ for the same staining modality 1808. For each staining modality 1808, one of the labeled image 1804 or the segmented image 1804′ may be fed into the synthesis classifier 1830 as input. By processing, the synthesis classifier 1830 may determine whether the input is from the labeled image 1804 (sometimes herein referred to in this context as the real image) or the segmented image 1804′ (sometimes herein referred to in this context as the fake image) for the same staining modality 1808. Based on the determination, the synthesis classifier 1830 may determine or generate a synthesis classification result 1836A-N (hereinafter generally referred to as a synthesis classification result 1836). The set of synthesis classification results 1836 may correspond to the set of staining modalities 1808 for the input images, such as the labeled image 1804 or the segmented image 1804′. The synthesis classification result 1836 may indicate whether the input to the synthesis classifier 1830 is the labeled image 1804 or the segmented image 1804′. The output of the synthesis classifier 1830 may be provided as one of the outputs 1812 of the overall image segmentation network 1740. The details of the discriminator 1824 are further discussed herein in conjunction with FIGS. 18(f)-(h).

Referring now to FIG. 18(c), depicted is a block diagram of an architecture 1840 for the generator 1822 in the image segmentation network 1740 in the system 1700 for quantifying conditions in biomedical images. In accordance with the architecture 1840, the modality synthesizer 1826 may include a set of modality generator blocks 1842B-N (hereinafter generally referred to as modality generator blocks 1842). Furthermore, the image segmenter 1828 may include a set of segmentation generator blocks 1844A-N (hereinafter generally referred to as segmentation generator blocks 1844) and at least one segmentation aggregator 1846. The set of kernels of the generator 1822 may be arranged across the modality generator blocks 1842, the segmentation generator blocks 1844, and the segmentation aggregator 1846.

In the modality synthesizer 1826, the set of modality generator blocks 1842 may correspond to the set of staining modalities 1808 to which to translate, transform, or convert the input image (e.g., the unlabeled image 1802). For example, the first modality generator block 1842B may be for generating images in the staining modality 1808B of DAPI, while the second modality generator block 1842C may be for generating images the staining modality 1808C of Lap2. In some embodiments, the set of staining modalities 1808 associated with the set of modality generator blocks 1842 may include those besides the staining modality 1808 of the input unlabeled image 1802.

Each modality generator block 1842 may identify, retrieve, or receive the unlabeled image 1802 (e.g., the first unlabeled image 1802A of the first staining modality 1808A). Upon receipt, the modality generator block 1842 may process the unlabeled image 1802 (e.g., the first unlabeled image 1802A of the first staining modality 1808A) using the set of kernels. In some embodiments, the modality generator blocks 1842 associated with modalities 1808 besides the modality 1808 identified for the input unlabeled image 1802 may be invoked for processing. From processing, the modality generator block 1842 may convert the unlabeled image 1802 from the original staining modality 1808 to produce or generate the synthesized image 1802′ of the associated staining modality 1808. The set of synthesized images 1802′ generated may be fed to the image segmenter 1828 and to the discriminator 1824 and as the output 1812 of the overall image segmentation network 1740.

In the image segmenter 1828, the set of segmentation generator blocks 1844 may correspond to the set of staining modalities 1808 from which to generate segmented images. For instance, the first segmentation generator block 1844A may generate segmented images from biomedical images in the first staining modality 1808A of Lap2. In contrast, the second segmentation generator block 1844B may generated segmented images from biomedical images of the second staining modality 1808B of CD3/CD8. Each segmentation generator block 1844 may identify, retrieve, or receive the synthesized image 1802′ for the staining modality 1808 for the segmentation generator block 1844. At least one of the segmentation generator blocks 1844 (e.g., the first segmentation generator block 1844A as depicted) may be associated with the staining modality 1808 of the original unlabeled image 1802 and receive the original unlabeled image 1802 for processing.

Each segmentation generator block 1844 may process the input synthesized image 1802′ (or the unlabeled image 1802) according to the set of kernel parameters. From processing, the segmentation generator block 1844 may produce or generate a segmented image 1804′ in the corresponding staining modality 1808. The segmented image 1804′ may identify the ROIs 1810 in the input synthesized image 1802′. In some embodiments, the segmented image 1804′ may identify the ROIs 1810 by presence or absence of the associated condition. The set of segmented images 1804′ may be fed to the input of the segmentation aggregator 1846 and to the discriminator 1824. In addition, the set of segmented images 1804′ may be provided as the output 1812 of the overall image segmentation network 1740.

In addition, the segmentation aggregator 1846 may retrieve, receive, or otherwise identify the set of segmented images 1804′ generated by the set of segmentation generator blocks 1844. Using the set of segmented images 1804′, the segmentation aggregator 1846 may produce or generate at least one aggregated segmented image 1848. In some embodiments, the segmentation aggregator 1846 may process the set of segmented images 1804′ in accordance with the set of kernels. In some embodiments, the segmentation aggregator 1846 may process the set of segmented images 1804′ using a combination function (e.g., a weighted average). The aggregated segmented image 1848 may identify one or more ROIs 1810 by condition. For example, the aggregated segmented image 1848 may identify the first ROI 1810A as present with the condition (e.g., lesion) and the second ROI 1810B and the third ROI 1810C as lacking the condition. The aggregated segmented image 1848 may be provided as the output 1812 of the overall image segmentation network 1740.

Referring now to FIG. 18(d), depicted is a block diagram depicting an architecture 1860 for a generator block 1862 in the generator 1822 of the image segmentation network 1740 in the system 1700 for quantifying conditions in biomedical images. The generator block 1862 may correspond to each modality generator block 1842 or each segmentation generator block 1844, and may be used to implement the modality generator block 1842 or the segmentation generator block 1844. In some embodiments, the generator block 1862 may correspond to the segmentation aggregator 1846, and may be used to implement the segmentation aggregator 1846.

The generator block 1862 may have at least one input, such as the unlabeled image 1802 for the modality generator block 1842, the synthesized image 1802′ for the segmentation generator block 1844, or the set of segmented images 1804′ for the segmentation aggregator 1846. The generator block 1862 may have at least one output, such as the synthesized image 1802′ of the modality generator block 1842, the segmented image 1804′ of the segmentation generator block 1844, or the aggregated segmented image 1848 of the segmentation aggregator 1846.

The generator block 1862 may include one or more deconvolution stacks 1864A-N (hereinafter generally referred to as deconvolution stacks 1864) to relate the input to the output. The input and the output of the generator block 1862 may be related via the set of kernels as defined in deconvolution stacks 1864. Each deconvolution stack 1864 may define or include the weights of the generator block 1862. The set of deconvolution stacks 1864 can be arranged in series (e.g., as depicted) or parallel configuration, or in any combination. In a series configuration, the input of one deconvolution stacks 1864 may include the output of the previous deconvolution stacks 1864 (e.g., as depicted). In a parallel configuration, the input of one deconvolution stack 1864 may include the input of the entire generator block 1862.

Referring now to FIG. 18(e), depicted is a block diagram of the deconvolution stack 1862 used in the generator 1822 in the image segmentation network 1740 in the system 1700 for quantifying conditions in biomedical images. Each deconvolution stack 1864 may have at least one up-sampler 1866 and a set of transform layers 1868A-N (hereinafter generally referred to as the transform layers 1868). The set of kernels for the generator block 1862 may be arranged across the transform layers 1868 of the deconvolution stack 1864.

The up-sampler 1866 may increase the image resolution of the input to increase a dimension (or resolution) to fit the set of transform layers 1868. In some implementations, the up-sampler 1866 can apply an up-sampling operation to increase the dimension of the input. The up-sampling operation may include, for example, expansion and an interpolation filter, among others. In performing the operation, the up-sampler 1866 may insert null (or default) values into the input to expand the dimension. The insertion or null values may separate the pre-existing values. The up-sampler 1866 may apply a filter (e.g., a low-pass frequency filter or another smoothing operation) to the expanded feature map. With the application, the up-sampler 1866 may feed the resultant output into the transform layers 1868.

The set of transform layers 1868 can be arranged in series, with an output of one transform layer 1868 fed as an input to a succeeding transform layer 1868. Each transform layer 1868 may have a non-linear input-to-output characteristic. The transform layer 1868 may comprise a convolutional layer, a normalization layer, and an activation layer (e.g., a rectified linear unit (ReLU)), among others. In some embodiments, the set of transform layers 1868 may be a convolutional neural network (CNN). For example, the convolutional layer, the normalization layer, and the activation layer (e.g., a rectified linear unit (ReLU)) may be arranged in accordance with a CNN.

Referring now to FIG. 18(f), depicted is a block diagram of an architecture 1880 for a discriminator 1824 in the image segmentation network 1740 in the system 1700 for quantifying conditions in biomedical images. In accordance with the architecture 1880, the synthesis classifier 1830 of the discriminator 1824 may include a set of modality classifier blocks 1882B-N (hereinafter generally referred to as modality classification blocks 1882). In addition, the segmentation classifier 1832 may include a set of segmentation classifier blocks 1884A-N (hereinafter generally referred to as segmentation classifier blocks 1884). The set of kernels of the discriminator 1824 may be arranged across the modality classifier blocks 1882 and the segmentation classifier blocks 1884.

In the synthesis classifier 1830, the set of modality classifier blocks 1882 may correspond to the set of staining modalities 1808 for which unsegmented images are to be discriminated as from the training dataset 1750 (e.g., real images) or from the modality synthesizer 1826 of the generator 1822 (e.g., fake images). For example, the first modality classifier block 1882B may be for distinguishing images in the staining modality 1808B of CD10, whereas the second modality classifier block 1882C may be for distinguishing images in the staining modality 1808C of Ki67. In some embodiments, the set of staining modalities 1808 associated with the set of modality classifier blocks 1848 may include those besides the staining modality 1808 of the input unlabeled image 1802 (e.g., the first unlabeled image 1802A in the first staining modality 1808A).

Each modality classifier block 1882 may identify, retrieve, or receive one of the original unlabeled image 1802 or the synthesized image 1802′ (e.g., as selected by the model trainer 1725) for a given staining modality 1808 as input. Upon receipt, the modality classifier block 1882 may process the input image using the set of kernels. In some embodiments, the modality classifier blocks 1882 associated with staining modalities 1808 besides the staining modality 1808 of the unlabeled image 1802 used to generate the synthesized images 1802′ may be invoked for processing. From processing, the modality classifier block 1882 may determine whether the input is generated by the modality synthesizer 1826 (e.g., a fake image) or from the training dataset 1750 (e.g., a real image). Based on the determination, the modality classifier block 1882 may determine, produce, or generate the modality classification result 1834 for the staining modality 1808. The modality classification result 1834 may indicate whether an input image is generated by the modality synthesizer 1826 (e.g., a fake image) or from the training dataset 1750 (e.g., a real image).

In the segmentation classifier 1832, the set of segmentation classifier blocks 1884 may correspond to the set of staining modalities 1808 for which segmented images are to be discriminated as from the training dataset 1750 (e.g., real images) or from the image segmenter 1828 of the generator 1822 (e.g., fake images). For instance, the first segmentation classifier block 1884A may distinguish segmented images for the first staining modality 1808A of Lap2, while the second segmentation classifier block 1884B may distinguish segmented images for the second staining modality 1808B of CD10. At least one of the segmentation classifier blocks 1884 (e.g., the first segmentation classifier block 1884A as depicted) may be associated with the staining modality 1808 of the original unlabeled image 1802 (e.g., the first unlabeled image 1804A).

Each segmentation classifier block 1884 may identify, retrieve, or receive one of the original labeled image 1804 or the segmented image 1804′ (e.g., as selected by the model trainer 1725) for a given staining modality 1808 as input. Upon receipt, the modality classifier block 1882 may process the input image using the set of kernels. From processing, the segmentation classifier block 1884 may determine whether the input is generated by the modality synthesizer 1826 (e.g., a fake image) or from the training dataset 1750 (e.g., a real image). Based on the determination, the modality classifier block 1882 may determine, produce, or generate the segmentation classification result 1834 for the staining modality 1808. The segmentation classification result 1834 may indicate whether the input image is generated by the image segmenter 1828 (e.g., a fake image) or from the training dataset 1750 (e.g., a real image).

Referring now to FIG. 18(g), depicted is a block diagram depicting an architecture 1890 for a classifier block 1892 in the discriminator 1824 of the image segmentation network 1740 in the system 1700 for quantifying conditions in biomedical images. The classifier block 1892 may correspond to each modality generator block 1842 or each segmentation generator block 1844, and may be used to implement the modality generator block 1842 or the segmentation generator block 1844. In some embodiments, the classifier block 1892 may correspond to the segmentation aggregator 1846, and may be used to implement the segmentation aggregator 1846.

The classifier block 1892 may have at least one input, such as the unlabeled image 1802 of the training dataset 1750, synthesized image 1802′ of the modality classifier block 1882, the labeled image 1804 of the training dataset 1750, and the segmented image 1804′ of the segmentation classifier block 1884. The classifier block 1892 may have at least one output, such as the modality classification results 1834 from the modality classifier block 1882 and the segmentation classification results 1836 from the segmentation classifier block 1884.

The classifier block 1892 may include one or more convolution stacks 1894A-N (hereinafter generally referred to as convolution stacks 1894) to relate the input to the output. The input and the output of the classifier block 1892 may be related via the set of kernels as defined in convolution stacks 1894. Each convolution stack 1894 may define or include the weights the classifier block 1892. The set of convolution stacks 1894 can be arranged in series (e.g., as depicted) or parallel configuration, or in any combination. In a series configuration, the input of one convolution stacks 1894 may include the output of the previous convolution stacks 1894 (e.g., as depicted). In parallel configuration, the input of one convolution stacks 1894 may include the input of the entire classifier block 1892.

Referring now to FIG. 18(h), depicted is a block diagram of the convolution stack 1894 used in the discriminator 1824 in the image segmentation network 1740 in the system 1700. Each convolution stack 1894 may have a set of transform layers 1896A-N (hereinafter generally referred to as the transform layers 1896). The set of kernels for the classifier block 1892 may be arranged across the transform layers 1868 of the convolution stack 1894. The set of transform layers 1896 can be arranged in series, with an output of one transform layer 1896 fed as an input to a succeeding transform layer 1896. Each transform layer 1896 may have a non-linear input-to-output characteristic. The transform layer 1896 may comprise a convolutional layer, a normalization layer, and an activation layer (e.g., a rectified linear unit (ReLU)), among others. In some embodiments, the set of transform layers 1896 may be a convolutional neural network (CNN). For example, the convolutional layer, the normalization layer, and the activation layer (e.g., a rectified linear unit (ReLU)) may be arranged in accordance with CNN.

In the context of FIG. 18(a), the model trainer 1725 may retrieve, obtain, or otherwise identify the output 1812 produced by the image segmentation network 1740 from applying the unlabeled images 1802 and labeled images 1804 of training dataset 1750. The output 1812 may identify or include the set of modality classification results 1834, the set of segmentation classification results 1836, the set of synthesized images 1802′, and the set of segmented images 1804′ across the set of staining modalities 1808. For each staining modality 1808, the output 1812 may include a corresponding modality classification result 1834, a segmentation classification result 1836, a synthesized image 1802′, and a segmented image 1804′. The corresponding input may include the unlabeled image 1802 and the labeled image 1804 of the same staining modality 1808 from the training dataset 1750.

With the identification, the model trainer 1725 may compare the output 1812 with the corresponding input. For each staining modality 1808, the model trainer 1725 may determine whether the modality classification result 1834 is correct. To determine, the model trainer 1725 may identify whether the unlabeled image 1802 or the synthesized image 1802′ was inputted into the synthesis classifier 1830 of the discriminator 1824. Upon identifying, the model trainer 1725 may compare whether the input matches the modality classification result 1834. If the two do not match, the model trainer 1725 may determine that the modality classification result 1834 is incorrect. Conversely, if the two match, the model trainer 1725 may determine that that the modality classification result 1834 is correct.

Likewise, the model trainer 1725 may determine whether the segmentation classification 1836 is correct. To determine, the model trainer 1725 may identify whether the labeled image 1804 or the segmented image 1804′ was inputted into the segmentation classifier 1832 of the discriminator 1824. Upon identifying, the model trainer 1725 may compare whether the input matches the segmentation classification result 1836. If the two do not match, the model trainer 1725 may determine that the segmentation classification result 1836 is incorrect. Conversely, if the two match, the model trainer 1725 may determine that the segmentation classification result 1836 is correct.

In addition, the model trainer 1725 may compare the unlabeled image 1802 with the corresponding synthesized image 1802′ generated by the modality synthesizer 1826 for the same modality 1808. In some embodiments, the comparison between the unlabeled image 1802 and the synthesized image 1802′ may be in a pixel-by-pixel manner. For each pixel, the model trainer 1725 may identify a color value of the pixel in the unlabeled image 1802 and a color value of the corresponding pixel of the synthesized image 1802′. With the identification, the model trainer 1725 may calculate or determine a difference in color value between the two pixels.

The model trainer 1725 may also compare the labeled image 1804 with the corresponding segmented image 1804′ generated by the image segmenter 1828 for the same modality 1808. In some embodiments, the comparison between the labeled image 1804 and the synthesized image 1802′ may be in a pixel-by-pixel manner. For each pixel, the model trainer 1725 may identify whether the labeled image 1804 indicates the pixel as part of the ROI 1810 (e.g., presence or lack of a condition) and whether the segmented image 1804′ indicates the pixel as part of the ROI 1810. The model trainer 1725 may determine whether the identifications with respect to the ROI 1810 match. In some embodiments, the model trainer 1725 may calculate or determine a number of pixels that match or a number of pixels that do not match.

Based on the comparisons, the model trainer 1725 may calculate or determine at least one error metric (sometimes herein referred to as a loss metric). The error metric may indicate a degree of deviation of the output 1812 from expected results based on the training dataset 1750. The error metric may be calculated in accordance with any number of loss functions, such as a Huber loss, norm loss (e.g., L1 or L2), mean squared error (MSE), a quadratic loss, and a cross-entropy loss, among others. In some embodiments, the model trainer 1725 may combine the results of the comparisons with respect to the output and the training dataset 1750 to calculate the error metric. In general, the higher the error metric, the more the output 1812 may have deviated from the expected result of the input. Conversely, the lower the error metric, the lower the output 1812 may have deviated from the expected result.

Using the error metric, the model trainer 1725 may modify, set, or otherwise update one or more of the kernel parameters of the image segmentation network 1740. In some embodiments, the model trainer 1725 may update the one or more of the kernel parameters across the generator 1822 and the discriminator 1824. The updating of kernels may be in accordance with an optimization function (or an objective function) for the image segmentation network 1740. The optimization function may define one or more rates or parameters at which the weights of the image segmentation network 1740 are to be updated. In some embodiments, the optimization function applied in updating the kernels in the generator 1822 may differ from the optimization function applied in updating the kernels in the discriminator 1824.

The updating of the kernels in the image segmentation network 1740 may be repeated until a convergence condition. Upon convergence, the model trainer 1725 may store and maintain at least the generator 1822 of the image segmentation network 1740 for use in scoring the condition on the biomedical images. In storing, the model trainer 1725 may store and maintain the set of kernels from the generator 1822 onto the database 1745. In addition, the model trainer 1725 may discard the discriminator 1824 (as well the set of kernels therein) of the image segmentation network 1740.

Referring now to FIG. 19, depicted is a block diagram of a process 1900 of applying the image segmentation network 1740 in the system 1700 for quantifying conditions in biomedical images. The process 1900 may correspond to or include the operations performed by the image quantification system 1705 under the runtime mode. Under process 1900, the imaging device 1710 may image or scan at least one sample 1900 to acquire at least one image 1910. Similar to the sample 1700, the sample 1905 may be a tissue sample obtained from a human or animal subject. In some embodiments, the acquisition of the image 1910 may be in accordance using immunostaining techniques (e.g., immunofluorescence) in accordance with a staining modality 1915 (e.g., the first staining modality 1915A as depicted). In some embodiments, the acquisition of the image 1910 may be in accordance with h a histopathological image preparer in accordance with the staining modality 1915. The staining modality 1915 may include, for example, any of the stains listed above in reference to the staining modality 1808, such as a stain selected to identify a particular antigen, protein, or other biomarker or a hematoxylin and eosin (H&E) for histological analysis, among others. The acquired image 1910 may have one or more ROIs 1920A-N (hereinafter generally referred to as ROIs 1920). The ROIs 1920 may correspond to a condition (e.g., presence or absence thereof) on an object (e.g., cell nuclei) in the sample 1905. As with the unlabeled images 1802 discussed above, the acquired image 1910 may lack any identification or annotations of the ROIs 1920. The acquired image 1910 may be new and different from any of the unlabeled images 1802. With the acquisition, the imaging device 1710 may send, transmit, or otherwise provide the acquired image 1910 to the image quantification system 1705.

The model applier 1730 may retrieve, receive, or otherwise identify the acquired image 1910 acquired or derived from the sample 1905 by the imaging device 1710. With the identification, the model applier 1730 may apply the acquired image 1910 to the image segmentation network 1740. In some embodiments, the application by the model applier 1730 may be subsequent to training of the image segmentation network 1740 (e.g., after convergence). As the image segmentation network 1740 is trained, the image segmentation network 1740 may have the generator 1822 and lack the discriminator 1824. In applying, the model applier 1730 may feed the acquired image 1910 into the generator 1822 of the image segmentation network 1740. The model applier 1730 may process the input acquired image 1910 in accordance with the set of kernels of the generator 1822.

By processing, the model applier 1730 may use the generator 1822 to produce or generate at least one output 1930. The output 1930 may identify or include a set of synthesized images 1910′B-N (hereinafter generally referred to synthesized images 1910′) and at least one segmented image 1925. From the modality synthesizer 1826 of the generator 1822, the model applier 1730 may obtain, retrieve, or otherwise identify the set of synthesized images 1910′ generated using the input acquired image 1910 for the output 1930. The set of synthesized images 1910′ may be generated by the modality synthesizer 1826 in a similar manner as described with respect to the synthesized images 1802′. The set of synthesized images 1910′ may be in other staining modalities 1915 besides the original staining modality 1915 of the input acquired image 1910. For example as depicted, the input acquired image 1910 may be in the first staining modality 1915A and the set of synthesized images 1910′ may be in all other staining modalities 1915B-N.

In addition, the model applier 1730 may obtain, retrieve, or otherwise identify the segmented image 1925 produced by the image segmenter 1828 of the generator 1822 for the output 1930. The segmented image 1925 may be generated by the image segmenter 1828 in a similar manner as detailed above with respect to the segmented images 1804′ and the aggregated segmented image 1848. For example, the segmented image 1925 generated by the image segmenter 1828 may correspond to the aggregated segmented image 1848 or one of the segmented images 1804′ in one of the staining modalities 1808. In some embodiments, the output 1930 may include multiple segmented images 1848 corresponding to the respective staining modalities 1808. Likewise, the segmented image 1925 may identify the one or more ROIs 1920 associated with the condition. In some embodiments, the segmented image 1925 may define or identify at least one ROI 1920 with the presence of the condition and at least one ROI 1920 lacking the condition. For instance, in the segmented image 1925, the first ROI 1920A may define a presence of the condition (e.g., cell nucleus with lesion) and the second ROI 1920B and the third ROI 1920C may define an absence of the condition (e.g., cell nuclei without any lesions).

The image scorer 1735 executing on the image quantification system 1705 may calculate or otherwise determine at least one score 1935 based on the segmented image 1925 generated by the image segmentation network 1740. The score 1935 may be a numeric value indicating a degree of the presence (or the absence) of the condition in the sample 1905 from which the segmented image 1925 is derived. To determine, the image scorer 1735 may identify a number of ROIs 1920 identified in the segmented image 1925. The image scorer 1735 may also identify a number of ROIs 1920 identified as having the condition and a number of ROIs 1920 identified as lacking the condition. For example, the image scorer 1735 may identify one number of ROIs 1920 corresponding to the number of cell nuclei with the lesion, another number of ROIs 1920 corresponding to the number of cell nuclei without any lesions, and a total number of ROIs 19120 corresponding to the total number of cell nuclei. Based on the number of ROIs 1920, the image scorer 1735 may determine the score 1935. In some embodiments, the image scorer 1735 may determine the score 1935 in accordance with a function (e.g., a weighted average).

In some embodiments, the image scorer 1735 may determine a set of scores 1935 for the corresponding set of segmented images 1925 in the various staining modalities 1915. Each score 1935 may be generated in a similar manner as discussed above, for example, using the number of ROIs 1920 identified by the respective segmented image 1925 in the corresponding staining modality 1915. Each score 1935 may be a numeric value indicating a degree of the presence or the absence of the condition in the sample 1905 under the corresponding staining modality 1915. For example, the image scorer 1735 may calculate one score 1935 indicating the percentage of cell nuclei with the lesion and another score 1935 indicating the percentage of cell nuclei without any lesions. In some embodiment images, the image scorer 1735 may determine an aggregate score 1935 based on the scores 1935 for the corresponding set of staining modalities 1915. The determination of the aggregate score 1935 may be in accordance with a function (e.g., a weighted average).

With the determination, the image scorer 1735 may generate information to present based on the score 1935, the set of synthesized images 1910′, or one or more of the segmented images 1925, among others, or any combination thereof. The image scorer 1735 may include the information as part of at least one output 1930′ for presentation. In some embodiments, the image scorer 1735 may include the information included in the output 1930′ based on the identified number of ROIs 1920. For example, the information in the output 1930′ may include the number of cell nuclei with a lesion, the number of cell nuclei without any lesion, and the total number of cell nuclei. In some embodiments, the image scorer 1735 may also identify the acquired image 1910 inputted into the image segmentation network 1740 used to generate the original output 1930. In some embodiments, the image scorer 1735 may provide the original acquired image 1910, the score 1935, the set of synthesized images 1910′, or one or more of the segmented images 1925, or any combination thereof as part of the output 1930′.

The image scorer 1735 may send, transmit, or otherwise provide the output 1930′ for presentation via the display 1715. The display 1715 may be part of the image quantification system 1705 or another device separate from the image quantification system 1705. The display 1715 may render or otherwise present the information included in the output 1930′, such as the score 1935, the set of synthesized images 1910′, one or more of the segmented images 1925, and other information, among others. For example, the display 1715 may render a graphical user interface to navigate presentations of the original acquired image 1910, the score 1935, the set of synthesized images 1910′, or one or more of the segmented images 1925, among others. The display 1715 may also present the total number of cell nuclei with or without a lesion, the number of cell nuclei with the lesion, and the percentage of cell nuclei with lesion, among others

In this manner, the image segmentation network 1740 in the image quantification system 1705 may be able to provide synthesized images 1910′ in various staining modalities 1915 that did not exist before using one acquired image 1910 in one staining modality 1915. Furthermore, the image segmentation network 1740 can generate the segmented image 1910′ identifying the ROIs 1920 in the original acquired image 1910 in a faster and more accurate fashion relative to other approaches detailed herein. In addition, the score 1935 calculated by the image scorer 1735 may provide a much more objective measure of the condition (e.g., tumorous cell nuclei) in comparison to a clinician manual examining the acquired image 1910.

Referring now to FIG. 20(a) is a flow diagram of a method 2000 of training models to quantify conditions on biomedical images. The method 2000 may be performed by or implemented using the system 1700 described herein in conjunction with FIGS. 17-19 or the system 2100 detailed herein in conjunction in Section C. Under method 2000, a computing system may identify a training dataset (2005). The computing system may establish an image segmentation network (2010). The computing system may determine an error metric (2015). The computing system may update the image segmentation network (2020). The computing system may store a generator from the image segmentation network (2025).

Referring now to FIG. 20(b), depicted a flow diagram of a method 2040 of quantifying conditions on biomedical images. The method 2040 may be performed by or implemented using the system 1700 described herein in conjunction with FIGS. 17-19 or the system 2100 detailed herein in conjunction in Section C. Under method 2040, a computing system may identify an acquired biomedical image (2045). The computing system may apply an image segmentation network (2050). The computing system may determine a score for a condition (2055). The computing system may provide an output (2060).

Referring now to FIG. 20(c), depicted is a flow diagram of a method 2070 of converting stain modalities in biomedical images. The method 2070 may be performed by or implemented using the system 1700 described herein in conjunction with FIGS. 17-19 or the system 2100 detailed herein in conjunction in Section C. Under method 2070, a computing system may identify a biomedical image in a modality (2075). The computing system may convert the modality of the biomedical image (2080). The computing system may generate a segmented biomedical image (2085). The computing system may provide an output (2090).

### C. Computing and Network Environment

Various operations described herein can be implemented on computer systems. FIG. 21 shows a simplified block diagram of a representative server system 2100, client computer system 2114, and network 2126 usable to implement certain embodiments of the present disclosure. In various embodiments, server system 2100 or similar systems can implement services or servers described herein or portions thereof. Client computer system 2114 or similar systems can implement clients described herein. The system 1700 described herein can be similar to the server system 2100. Server system 2100 can have a modular design that incorporates a number of modules 2102 (e.g., blades in a blade server embodiment); while two modules 2102 are shown, any number can be provided. Each module 2102 can include processing unit(s) 2104 and local storage 2106.

Processing unit(s) 2104 can include a single processor, which can have one or more cores, or multiple processors. In some embodiments, processing unit(s) 2104 can include a general-purpose primary processor as well as one or more special-purpose co-processors such as graphics processors, digital signal processors, or the like. In some embodiments, some or all processing units 2104 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 2104 can execute instructions stored in local storage 2106. Any type of processors in any combination can be included in processing unit(s) 2104.

Local storage 2106 can include volatile storage media (e.g., DRAM, SRAM, SDRAM, or the like) and/or non-volatile storage media (e.g., magnetic or optical disk, flash memory, or the like). Storage media incorporated in local storage 2106 can be fixed, removable or upgradeable as desired. Local storage 2106 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 2104 need at runtime. The ROM can store static data and instructions that are needed by processing unit(s) 2104. The permanent storage device can be a non-volatile read-and-write memory device that can store instructions and data even when module 2102 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 2106 can store one or more software programs to be executed by processing unit(s) 2104, such as an operating system and/or programs implementing various server functions such as functions of the system 1700 of FIG. 17 or any other system described herein, or any other server(s) associated with system 1700 or any other system described herein.

“Software” refers generally to sequences of instructions that, when executed by processing unit(s) 2104 cause server system 2100 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 2104. Software can be implemented as a single program or a collection of separate programs or program modules that interact as desired. From local storage 2106 (or non-local storage described below), processing unit(s) 2104 can retrieve program instructions to execute and data to process in order to execute various operations described above.

In some server systems 2100, multiple modules 2102 can be interconnected via a bus or other interconnect 2108, forming a local area network that supports communication between modules 2102 and other components of server system 2100. Interconnect 2108 can be implemented using various technologies including server racks, hubs, routers, etc.

A wide area network (WAN) interface 2110 can provide data communication capability between the local area network (interconnect 2108) and the network 2126, such as the Internet. Technologies can be used, including wired (e.g., Ethernet, IEEE 802.3 standards) and/or wireless technologies (e.g., Wi-Fi, IEEE 802.11 standards).

In some embodiments, local storage 2106 is intended to provide working memory for processing unit(s) 2104, providing fast access to programs and/or data to be processed while reducing traffic on interconnect 2108. Storage for larger quantities of data can be provided on the local area network by one or more mass storage subsystems 2112 that can be connected to interconnect 2108. Mass storage subsystem 2112 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 2112. In some embodiments, additional data storage resources may be accessible via WAN interface 2110 (potentially with increased latency).

Server system 2100 can operate in response to requests received via WAN interface 2110. For example, one of modules 2102 can implement a supervisory function and assign discrete tasks to other modules 2102 in response to received requests. Work allocation techniques can be used. As requests are processed, results can be returned to the requester via WAN interface 2110. Such operation can generally be automated. Further, in some embodiments, WAN interface 2110 can connect multiple server systems 2100 to each other, providing scalable systems capable of managing high volumes of activity. Other techniques for managing server systems and server farms (collections of server systems that cooperate) can be used, including dynamic resource allocation and reallocation.

Server system 2100 can interact with various user-owned or user-operated devices via a wide-area network such as the Internet. An example of a user-operated device is shown in FIG. 21 as client computing system 2114. Client computing system 2114 can be implemented, for example, as a consumer device such as a smartphone, other mobile phone, tablet computer, wearable computing device (e.g., smart watch, eyeglasses), desktop computer, laptop computer, and so on.

For example, client computing system 2114 can communicate via WAN interface 2110. Client computing system 2114 can include computer components such as processing unit(s) 2116, storage device 2118, network interface 2120, user input device 2122, and user output device 2124. Client computing system 2114 can be a computing device implemented in a variety of form factors, such as a desktop computer, laptop computer, tablet computer, smartphone, other mobile computing device, wearable computing device, or the like.

Processor 2116 and storage device 2118 can be similar to processing unit(s) 2104 and local storage 2106 described above. Suitable devices can be selected based on the demands to be placed on client computing system 2114; for example, client computing system 2114 can be implemented as a “thin” client with limited processing capability or as a high-powered computing device. Client computing system 2114 can be provisioned with program code executable by processing unit(s) 2116 to enable various interactions with server system 2100.

Network interface 2120 can provide a connection to the network 2126, such as a wide area network (e.g., the Internet) to which WAN interface 2110 of server system 2100 is also connected. In various embodiments, network interface 2120 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 2122 can include any device (or devices) via which a user can provide signals to client computing system 2114; client computing system 2114 can interpret the signals as indicative of particular user requests or information. In various embodiments, user input device 2122 can include any or all of a keyboard, touch pad, touch screen, mouse or other pointing device, scroll wheel, click wheel, dial, button, switch, keypad, microphone, and so on.

User output device 2124 can include any device via which client computing system 2114 can provide information to a user. For example, user output device 2124 can include display-to-display images generated by or delivered to client computing system 2114. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 2124 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 2104 and 2116 can provide various functionality for server system 2100 and client computing system 2114, including any of the functionality described herein as being performed by a server or client, or other functionality.

It will be appreciated that server system 2100 and client computing system 2114 are illustrative and that variations and modifications are possible. Computer systems used in connection with embodiments of the present disclosure can have other capabilities not specifically described here. Further, while server system 2100 and client computing system 2114 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies including but not limited to specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished; e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or digital versatile disk (DVD), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

What is claimed is:

1. A method of converting staining modalities in biomedical images, comprising:
identifying, by a computing system, a first biomedical image in a first staining modality, the first biomedical image having at least one region of interest (ROI) corresponding to a condition;
converting, by the computing system, the first biomedical image from the first staining modality to a second staining modality to generate a second biomedical image;
generating, by the computing system, a segmented biomedical image by applying an image segmentation network to at least one of the first biomedical image or the second biomedical image, the segmented biomedical image identifying one or more ROIs; and
providing, by the computing system, an output identifying information based on at least one of the second biomedical image or the segmented biomedical image.

2. A method of training models to quantify conditions on biomedical images, comprising:
identifying, by a computing system, a training dataset comprising a plurality of biomedical images in a corresponding plurality of staining modalities, the plurality of biomedical images having at least a first biomedical image in a first staining modality of the plurality of staining modalities, the first biomedical image having at least one region of interest (ROI) associated with a condition;
establishing, by the computing system, an image segmentation network using the training dataset, the image segmentation network comprising:
a first model having a first plurality of kernels, configured to:
generate a second biomedical image in a second staining modality using the first biomedical image in the first staining modality; and
generate a segmented biomedical image using the first biomedical image and the second biomedical image, the segmented biomedical image identifying the ROI;
a second model having a second plurality of kernels configured to generate a classification using the segmented biomedical image, the classification indicating whether the segmented biomedical image is generated using the first model; and
determining, by the computing system, an error metric based on the classification generated by the second model;
updating, by the computing system, at least one of the first plurality of kernels in the first model or the second plurality of kernels in the second model using the error metric; and
storing, by the computing system, the first plurality of kernels in the first model of the image segmentation network for generating scores for presence of the condition in biomedical images.

3. The method of claim 2, further comprising:
applying, by the computing system subsequent to convergence of the image segmentation network, the first model of the image segmentation network to an acquired biomedical image in one of the plurality of staining modalities to generate a second segmented biomedical image, the second segmented biomedical image identifying one or more ROIs associated with the condition in the acquired biomedical images; and
determining, by the computing system, a score for the condition in the acquired biomedical image based on a number of the one or more ROIs.

4. The method of claim 2, wherein the training dataset further comprises a labeled biomedical image associated with the plurality of biomedical images, the labeled biomedical image identifying the at least one ROI in at least the first biomedical image; and
wherein the second model is further configured to generate the classification using at least one of the segmented biomedical image or the labeled biomedical image, the classification indicating whether the segmented biomedical image or the labeled biomedical image is input into the second model.

5. The method of claim 2, wherein the second model is further configured to generate a second classification using at least one of the second biomedical image or a biomedical image of the plurality of biomedical images in the second staining modality, the second classification indicating whether the second biomedical image or the biomedical image is input into the second model; and
wherein determining the loss metric further comprises determining the loss metric based on the second classification generated by the second model.

6. The method of claim 2, wherein the first plurality of kernels of the first model is arranged across:
a plurality of first blocks corresponding to the plurality of staining modalities besides the first staining modality, the first plurality of blocks to generate a corresponding plurality of second biomedical images corresponding to the first biomedical image, each of the plurality of second biomedical images in a staining modality different from the first staining modality;
a plurality of second blocks corresponding to the plurality of staining modalities, the plurality of second blocks to generate a corresponding plurality of segmented biomedical images using the plurality of second biomedical images; and
a third block to generate the segmented biomedical image using the plurality of segmented biomedical images.

7. The method of claim 2, wherein the second plurality of kernels of the second model is arranged across:
a plurality of first blocks corresponding to the plurality of staining modalities besides the first staining modality, the plurality of first blocks to generate a plurality of first classifications using a plurality of second biomedical images generated using the first biomedical image; and
a plurality of second blocks corresponding to the plurality of staining modalities, the plurality of second blocks to generate a plurality of second classifications using a plurality of segmented biomedical images.

8. The method of claim 2, wherein each of the plurality of biomedical images in the training dataset is derived from a tissue sample in accordance with immunostaining of a corresponding staining modality of the plurality of staining modalities, and
wherein the plurality of staining modalities for the plurality of biomedical images corresponds to a respective plurality of antigens present in the tissue sample.

9. A method of quantifying conditions on biomedical images, comprising:
identifying, by a computing system, a first biomedical image in a first staining modality, the first biomedical image having at least one region of interest (ROI) corresponding to a condition;
applying, by the computing system, a trained image segmentation model to the first biomedical image, the trained image segmentation model having a plurality of kernels, the plurality of kernels configured to:
generate a second biomedical image in a second staining modality using the first biomedical image in the first staining modality;
generate a segmented biomedical image using the first biomedical image and the second biomedical image, the segmented biomedical image identifying one or more ROIs;
determining, by the computing system, a score for the condition in the first biomedical image based on the one or more ROIs identified in the segmented biomedical image; and
providing, by the computing system, an output based on at least one of the second biomedical image, the score for the condition, or the segmented biomedical image.

10. The method of claim 9, further comprising establishing, by the computing system, the trained image segmentation model using a training dataset, the training dataset comprising (i) a plurality of unlabeled biomedical images in the corresponding plurality of staining modalities and (ii) a labeled biomedical image identifying at least one ROI in one of the plurality of unlabeled biomedical images.

11. The method of claim 9, wherein the first plurality of kernels of the first model is arranged across:
a plurality of first blocks corresponding to the plurality of staining modalities besides the first staining modality, the first plurality of blocks to generate a corresponding plurality of second biomedical images corresponding to the first biomedical image, each of the plurality of second biomedical images in a staining modality different from the first staining modality;
a plurality of second blocks corresponding to the plurality of staining modalities, the plurality of second blocks to generate a corresponding plurality of segmented biomedical images using the plurality of second biomedical images; and
a third block to generate the segmented biomedical image using the plurality of segmented biomedical images.

12. The method of claim 9, wherein determining the score further comprises determining a plurality of scores for the plurality of staining modalities based on a plurality of segmented images corresponding to the plurality of staining modalities.

13. The method of claim 9, wherein identifying the first biomedical image further comprises receiving the first biomedical image acquired from a tissue sample in accordance with immunostaining of the first staining modality, the first biomedical image having the at least one ROI corresponding to a feature associated with the condition in the tissue sample.

14. The method of claim 9, wherein providing the output further comprises generating information to present based on the score for the condition and the segmented biomedical image, the segmented biomedical image identifying the one or more ROIs, the one or more ROIs corresponding to one of a presence of the condition or an absence of the condition.

15. A system for training models to segment biomedical images to quantify conditions, comprising:
a computing system having one or more processors coupled with memory, configured to:
identify a training dataset comprising a plurality of biomedical images in a corresponding plurality of staining modalities, the plurality of biomedical images having at least a first biomedical image in a first staining modality of the plurality of staining modalities, the first biomedical image having at least one region of interest (ROI) associated with a condition;
establish an image segmentation network using the training dataset, the image segmentation network comprising:
a first model having a first plurality of kernels, configured to:
generate a second biomedical image in a second staining modality using the first biomedical image in the first staining modality; and
generate a segmented biomedical image using the first biomedical image and the second biomedical image, the segmented biomedical image identifying the ROI;
a second model having a second plurality of kernels configured to generate a classification using the segmented biomedical image, the classification indicating whether the segmented biomedical image is generated using the first model; and
determine an error metric based on the classification generated by the second model;
update at least one of the first plurality of kernels in the first model or the second plurality of kernels in the second model using the error metric; and
store the first plurality of kernels in the first model of the image segmentation network for generating scores for presence of the condition in biomedical images.

16. The system of claim 15, wherein the computing system is further configured to:
apply, subsequent to convergence of the image segmentation network, the first model of the image segmentation network to an acquired biomedical image in one of the plurality of staining modalities to generate a second segmented biomedical image, the second segmented biomedical image identifying one or more ROIs associated with the condition in the acquired biomedical images; and
determine a score for the condition in the acquired biomedical image based on a number of the one or more ROIs.

17. The system of claim 15, wherein the training dataset further comprises a labeled biomedical image associated with the plurality of biomedical images, the labeled biomedical image identifying the at least one ROI in at least the first biomedical image; and
wherein the second model is further configured to generate the classification using at least one of the segmented biomedical image or the labeled biomedical image, the classification indicating whether the segmented biomedical image or the labeled biomedical image is input into the second model.

18. The system of claim 15, wherein the second model is further configured to generate a second classification using at least one of the second biomedical image or a biomedical image of the plurality of biomedical images in the second staining modality, the second classification indicating whether the second biomedical image or the biomedical image is input into the second model; and
wherein the computing system is further configured to determine the loss metric based on the second classification generated by the second model.

19. The system of claim 15, wherein the first plurality of kernels of the first model is arranged across:
a plurality of first blocks corresponding to the plurality of staining modalities besides the first staining modality, the first plurality of blocks to generate a corresponding plurality of second biomedical images corresponding to the first biomedical image, each of the plurality of second biomedical images in a staining modality different from the first staining modality; and
a plurality of second blocks corresponding to the plurality of staining modalities, the plurality of second blocks to generate a corresponding plurality of segmented biomedical images using the plurality of second biomedical images.

20. The system of claim 15, wherein the second plurality of kernels of the second model is arranged across:
a plurality of first blocks corresponding to the plurality of staining modalities besides the first staining modality, the plurality of first blocks to generate a plurality of first classifications using a plurality of second biomedical images generated using the first biomedical image;
a plurality of second blocks corresponding to the plurality of staining modalities, the plurality of second blocks to generate a plurality of second classifications using a plurality of segmented biomedical images, and
a third block to generate the classification based on the first plurality of classifications and the second plurality of classifications.

21. The system of claim 15, wherein each of the plurality of biomedical images in the training dataset is derived from a tissue sample in accordance with immunostaining of a corresponding staining modality of the plurality of staining modalities, and
wherein the plurality of staining modalities for the plurality of biomedical images corresponds to a respective plurality of antigens present in the tissue sample.
